(19) United States
(12) Patent Application Publication
(10) Pub. No.: US 2026/0339081 A1
(43) Pub. Date: Oct. 29, 2026

(54) ZOOM LENS AND IMAGE PICKUP APPARATUS

(71) Applicant: CANON KABUSHIKI KAISHA, Tokyo (JP)

(72) Inventor: Naotoshi OGAWA, Tochigi (JP)

(21) Appl. No.: 19/657,165

(22) Filed: Apr. 24, 2026

(30) Foreign Application Priority Data
Apr. 28, 2025 (JP) 2025-074245

(51) Int. Cl. G02B 13/00; G02B 3/00; G02B 7/02; G02B 15/14

(52) U.S. Cl. CPC G02B 13/009; G02B 7/025; G02B 13/0045; G02B 13/006; G02B 15/145125; G02B 2003/0093

(57) ABSTRACT

A zoom lens including: in order from an object side, a first positive lens unit that does not move for zooming, a variable-magnification lens unit including a plurality of lens units that move for zooming, and a rear lens unit that does not move for zooming, in which an interval between each adjacent lens units changes during zooming, in which the zoom lens includes an aberration-changing lens unit to change aberration by being inserted into and removed from an optical path in the rear lens unit; and in which the zoom lens includes a switching unit for switching between arrangement and retracted states where the aberration-changing lens unit is arranged in/retracted from the optical path, and in which focal lengths at the wide angle end in the retracted and arrangement states, back focuses at the wide angle end in the retracted and arrangement states are appropriately set.

### BACKGROUND

### Field of the Technology

The present disclosure relates to a zoom lens and an image pickup apparatus.

### Description of the Related Art

In recent years, in the broadcasting industry, high-resolution imaging technologies such as 4K and 8K have been rapidly developed. Along with this, various techniques have been developed for an image pickup lens for a broadcast camera, such as a multi-unit configuration in which a plurality of lens units are moved to cope with high resolution.

On the other hand, in a live broadcast such as a sports broadcast, in addition to a sharply expressed image, a cinema-like expression is required. Specifically, it is required that high-resolution imaging is normally performed, and at a certain timing, imaging can be selectively performed in various expressions, for example, blurring is performed in order to make a subject conspicuous.

Japanese Patent Laid-Open No. 2019-207267 and Japanese Patent Laid-Open No. 2020-122889 disclose an image pickup optical system having a so-called soft focus function in which spherical aberration is changed by moving a part of lens units in the optical axis direction.

However, in the optical systems disclosed in Japanese Patent Laid-Open No. 2019-207267 and Japanese Patent Laid-Open No. 2020-122889, since the lens unit is moved in the optical axis direction in order to acquire a soft-focused image, when the image is switched during live broadcasting, the field of view of the image changes, and resulting in an image of uncomfortable feeling.

### SUMMARY

Therefore, the present disclosure provides a zoom lens that is small in size and that can capture images having the same image pickup magnification and different video image representations.

According to one aspect of the present disclosure, a zoom lens includes: in order from an object side to an image side, a first lens unit having a positive refractive power that does not move for zooming, a variable-magnification lens unit including a plurality of lens units that move for zooming, and a rear lens unit that does not move for zooming, in which an interval between each lens units adjacent to each other changes during zooming, in which the zoom lens includes an aberration-changing lens unit including one or more lenses and configured to change aberration of the zoom lens by being inserted into and removed from an optical path in the rear lens unit; and, in which the zoom lens includes a switching unit for switching between an arrangement state in which the aberration-changing lens unit is arranged in the optical path in the rear lens unit and a retracted state in which the aberration-changing lens unit is retracted from the optical path, and in which the following inequalities are satisfied,

0.80≤fwa/fw≤1.20

0.95≤skwa/skw≤1.05

where fw represents a focal length of the zoom lens at the wide angle end in the retracted state, fwa represents a focal length of the zoom lens at the wide angle end in the arrangement state, skw represents a back focus at the wide angle end in the retracted state, and skwa represents a back focus at the wide angle end in the arrangement state.

Note that an image pickup apparatus that performs imaging through the zoom lens also constitutes another aspect of the present disclosure.

Features of the present disclosure will become apparent from the following description of embodiments with reference to the attached drawings. The following description of embodiments is described by way of embodiment.

### BRIEF DESCRIPTION OF THE DRAWINGS

FIG. 1 is a cross-sectional view of zoom lenses according to Embodiments 1 to 7 at a wide angle end when focusing on infinity in a state where an aberration-changing lens unit is not located in an optical path.

FIG. 2A is an aberration diagram of the zoom lenses of Embodiments 1 to 7 at the wide angle end when focusing on infinity in a state where the aberration-changing lens unit is not located in the optical path.

FIG. 2B is an aberration diagram of the zoom lenses of Embodiments 1 to 7 at an intermediate zoom position when focusing on infinity in a state where the aberration-changing lens unit is not located in the optical path.

FIG. 2C is an aberration diagram of the zoom lenses of Embodiments 1 to 7 at a telephoto end when focusing on infinity in a state where the aberration-changing lens unit is not located in the optical path.

FIG. 3 is a cross-sectional view of the zoom lens according to Embodiment 1 at the wide angle end when focusing on infinity in a state where the aberration-changing lens unit is located in the optical path.

FIG. 4A is an aberration diagram of the zoom lens according to Embodiment 1 at the wide angle end when focusing on infinity in a state where the aberration-changing lens unit is located in the optical path.

FIG. 4B is an aberration diagram of the zoom lens according to Embodiment 1 at the intermediate zoom position when focusing on infinity in a state where the aberration-changing lens unit is located in the optical path.

FIG. 4C is an aberration diagram of the zoom lens according to Embodiment 1 at the telephoto end when focusing on infinity in a state where the aberration-changing lens unit is located in the optical path.

FIG. 5 is a cross-sectional view of a zoom lens according to Embodiment 2 at the wide angle end when focusing on infinity in a state where an aberration-changing lens unit is located in the optical path.

FIG. 6A is an aberration diagram of the zoom lens according to Embodiment 2 at the wide angle end when focusing on infinity in a state where the aberration-changing lens unit is located in the optical path.

FIG. 6B is an aberration diagram of the zoom lens according to Embodiment 2 at the intermediate zoom position when focusing on infinity in a state where the aberration-changing lens unit is located in the optical path.

FIG. 6C is an aberration diagram of the zoom lens according to Embodiment 2 at the telephoto end when focusing on infinity in a state where the aberration-changing lens unit is located in the optical path.

FIG. 7 is a cross-sectional view of a zoom lens according to Embodiment 3 at the wide angle end when focusing on infinity in a state where an aberration-changing lens unit is located in an optical path.

FIG. 8A is an aberration diagram of the zoom lens according to Embodiment 3 at the wide angle end when focusing on infinity in a state where the aberration-changing lens unit is located in the optical path.

FIG. 8B is an aberration diagram of the zoom lens according to Embodiment 3 at the intermediate zoom position when focusing on infinity in a state where the aberration-changing lens unit is located in the optical path.

FIG. 8C is an aberration diagram of the zoom lens according to Embodiment 3 at the telephoto end when focusing on infinity in a state where the aberration-changing lens unit is located in the optical path.

FIG. 9 is a cross-sectional view of a zoom lens according to Embodiment 4 at the wide angle end when focusing on infinity in a state where the aberration-changing lens unit is located in an optical path.

FIG. 10A is an aberration diagram of the zoom lens according to Embodiment 4 at the wide angle end when focusing on infinity in a state where the aberration-changing lens unit is located in the optical path.

FIG. 10B is an aberration diagram of the zoom lens according to Embodiment 4 at the intermediate zoom position when focusing on infinity in a state where the aberration-changing lens unit is located in the optical path.

FIG. 10C is an aberration diagram of the zoom lens according to Embodiment 4 at the telephoto end when focusing on infinity in a state where the aberration-changing lens unit is located in the optical path.

FIG. 11 is a cross-sectional view of the zoom lens according to Embodiment 5 at the wide angle end when focusing on infinity in a state where the aberration-changing lens unit is located in an optical path.

FIG. 12A is an aberration diagram of the zoom lens according to Embodiment 5 at the wide angle end when focusing on infinity in a state where the aberration-changing lens unit is located in the optical path.

FIG. 12B is an aberration diagram of the zoom lens according to Embodiment 5 at the intermediate zoom position when focusing on infinity in a state where the aberration-changing lens unit is located in the optical path.

FIG. 12C is an aberration diagram of the zoom lens according to Embodiment 5 at the telephoto end when focusing on infinity in a state where the aberration-changing lens unit is located in the optical path.

FIG. 13 is a cross-sectional view of the zoom lens according to Embodiment 6 at the wide angle end when focusing on infinity in a state where the aberration-changing lens unit is located in an optical path.

FIG. 14A is an aberration diagram of the zoom lens according to Embodiment 6 at the wide angle end when focusing on infinity in a state where the aberration-changing lens unit is located in the optical path.

FIG. 14B is an aberration diagram of the zoom lens according to Embodiment 6 at the intermediate zoom position when focusing on infinity in a state where the aberration-changing lens unit is located in the optical path.

FIG. 14C is an aberration diagram of the zoom lens according to Embodiment 6 at the telephoto end when focusing on infinity in a state where the aberration-changing lens unit is located in the optical path.

FIG. 15 is a cross-sectional view of a zoom lens according to Embodiment 7 at a wide angle end when focusing on infinity in a state where an aberration-changing lens unit is located in an optical path.

FIG. 16A is an aberration diagram of the zoom lens according to Embodiment 7 at the wide angle end when focusing on infinity in a state where the aberration-changing lens unit is located in the optical path.

FIG. 16B is an aberration diagram of the zoom lens according to Embodiment 7 at the intermediate zoom position when focusing on infinity in a state where the aberration-changing lens unit is located in the optical path.

FIG. 16C is an aberration diagram of the zoom lens according to Embodiment 7 at the telephoto end when focusing on infinity in a state where the aberration-changing lens unit is located in the optical path.

FIG. 17 is a cross-sectional view of a zoom lens according to Embodiment 8 at the wide angle end when focusing on infinity in a state where the aberration-changing lens unit and an extender lens unit are not located in an optical path.

FIG. 18A is an aberration diagram of the zoom lens according to Embodiment 8 at the wide angle end when focusing on infinity in a state where the aberration-changing lens unit and the extender lens unit are not located in the optical path.

FIG. 18B is an aberration diagram of the zoom lens according to Embodiment 8 at the intermediate zoom position when focusing on infinity in a state where the aberration-changing lens unit and the extender lens unit are not located in the optical path.

FIG. 18C is an aberration diagram of the zoom lens according to Embodiment 8 at the telephoto end when focusing on infinity in a state where the aberration-changing lens unit and the extender lens unit are not located in the optical path.

FIG. 19 is a cross-sectional view of the zoom lens according to Embodiment 8 at the wide angle end when focusing on infinity in a state where the aberration-changing lens unit is located in an optical path.

FIG. 20A is an aberration diagram of the zoom lens according to Embodiment 8 at the wide angle end when focusing on infinity in a state where the aberration-changing lens unit is located in the optical path.

FIG. 20B is an aberration diagram of the zoom lens according to Embodiment 8 at the intermediate zoom position when focusing on infinity in a state where the aberration-changing lens unit is located in the optical path.

FIG. 20C is an aberration diagram of the zoom lens according to Embodiment 8 at the telephoto end when focusing on infinity in a state where the aberration-changing lens unit is located in the optical path.

FIG. 21 is a cross-sectional view of the zoom lens according to Embodiment 8 at the wide angle end when focusing on infinity in a state where the extender lens unit is located in an optical path.

FIG. 22A is an aberration diagram of the zoom lens according to Embodiment 8 at the wide angle end when focusing on infinity in a state where the extender lens unit is located in the optical path.

FIG. 22B is an aberration diagram of the zoom lens according to Embodiment 8 at the intermediate zoom position when focusing on infinity in a state where the extender lens unit is located in the optical path.

FIG. 22C is an aberration diagram of the zoom lens according to Embodiment 8 at the telephoto end when focusing on infinity in a state where the extender lens unit is located in the optical path.

FIG. 23 is a schematic configuration diagram illustrating a configuration of an image pickup apparatus.

### DESCRIPTION OF THE EMBODIMENTS

Hereinafter, Embodiments of the present disclosure will be described with reference to the drawings.

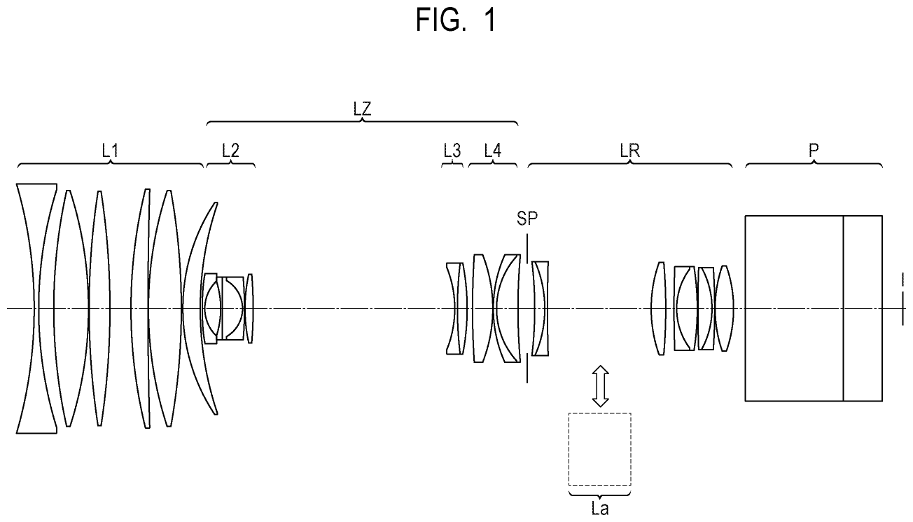

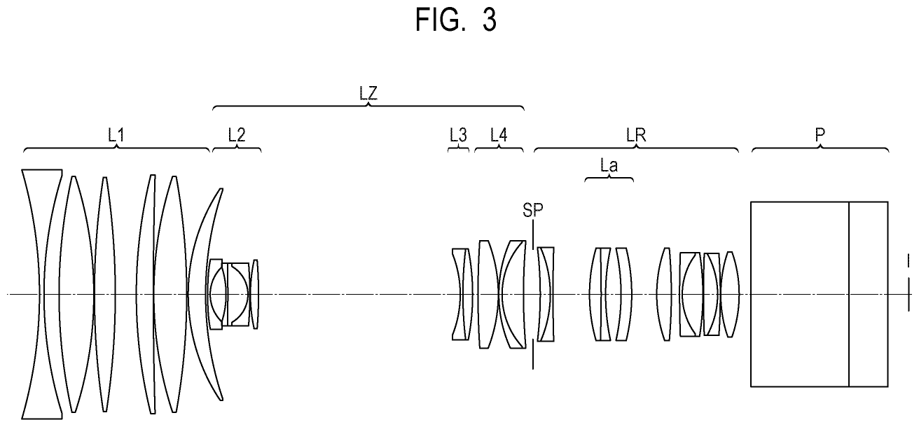

Prior to describing specific Embodiments 1 to 8, matters common to the zoom lens of each Embodiment will be described with reference to FIGS. 1 and 3 showing the zoom lens of Embodiment 1.

FIG. 1 is a cross-sectional view of the zoom lenses of Embodiments 1 to 7 in a state (retracted state) in which the aberration-changing lens unit La configured to be insertable into and removable from the optical path is at the retracted position and is not located in the optical path, at the time of focusing on infinity at the wide angle end. FIG. 3 is a cross-sectional view of the zoom lens of Embodiment 1 in a state (arrangement state) in which the aberration-changing lens unit La is inserted into the optical path and located on the optical path at the time of focusing on infinity at the wide angle end.

In the zoom lens, the lens unit is a set of one or a plurality of lenses that move integrally during zooming (changing magnification) between the wide angle end and the telephoto end. That is, the distance between adjacent lens units changes during zooming. The lens unit may include an aperture stop. In addition, the wide angle end and the telephoto end respectively show zoom states of a maximum angle of view (a shortest focal length) and a minimum angle of view (a maximum focal length) when the lens unit that moves during zooming is positioned at both ends of a movable range on the optical axis in terms of mechanism or control.

The zoom lens of each embodiment includes, in order from the object side to the image side, a first lens unit L1, a variable-magnification lens unit LZ, an aperture stop SP, and a rear lens unit (relay lens unit) LR.

The first lens unit L1 is immovable (does not move) with respect to the image plane for zooming, and has a positive refractive power.

The second lens unit L2 having a negative refractive power, the third lens unit L3 having a negative refractive power, and the fourth lens unit L4 having a positive refractive power are variable-magnification lens units LZ that move in the optical axis direction along different trajectories during zooming. The second lens unit L2 monotonously moves toward the image side during zooming from the wide angle end to the telephoto end. The third lens unit L3 moves non-monotonically along a locus of a convex shape toward the object side during zooming from the wide angle end to the telephoto end. The fourth lens unit L4 moves non-monotonically during zooming from the wide angle end to the telephoto end. The variable magnification lens unit LZ may include other lens units.

The aperture stop SP is immovable for zooming. The rear lens unit LR is immovable for zooming and has a positive refractive power.

The rear lens unit LR includes an aberration-changing lens unit La configured to be capable of being inserted into and removed from an optical path between the frontmost surface and the rearmost surface of the lenses constituting the rear lens unit LR. By inserting and removing the aberration-changing lens unit La into and from the optical path and switching between a state in which the aberration-changing lens unit La is located in the optical path (FIG. 3) and a state in which the aberration-changing lens unit La is not located in the optical path (FIG. 1), it is possible to perform imaging with different video image representations.

The aberration-changing lens unit La includes one or more lenses. For example, a turret-type switching unit can be used as a mechanism for inserting and removing the aberration-changing lens unit La into and from the optical path in the rear lens unit LR, but the present disclosure is not limited to this configuration.

I is the image plane. An imaging surface (light receiving surface) of the image pickup element and a film surface (photosensitive surface) of the silver halide film are disposed on the image plane I. A glass block such as a prism or an optical filter may be disposed between the zoom lens and the image plane I. In the cross-sectional view of the zoom lens attached hereto, a glass block is shown with reference sign P.

During focusing (focus adjustment) from a long-distance object to a short-distance object, all or part of the first lens unit L1 moves in the optical axis direction.

In the zoom lens of each embodiment (each numerical embodiment described later), the following condition is satisfied,

0.80≤fwa/fw≤1.20 (1)

where fw represents a focal length of the zoom lens at the wide angle end in a state where the aberration-changing lens unit La is not located in the optical path and fwa represents a focal length of the zoom lens at the wide angle end in a state where the aberration-changing lens unit La is located in the optical path.

The inequality (1) indicates a condition for obtaining a zoom lens in which picking up images with the same imaging magnification and different video image representations can be switched without causing uncomfortable feeling. When fwa/fw exceeds the upper and lower limits of the inequality (1), the change in the image pickup magnification becomes too large, resulting in an image of uncomfortable feeling when the image is switched.

Further, it is preferable that the zoom lens of each embodiment satisfies at least one of the following inequalities (2) to (10).

In the zoom lens of each embodiment, it is preferable that the following condition is satisfied,

0.95≤skwa/skw≤1.05 (2)
where skw represents the back focus at the wide angle end in a state where the aberration-changing lens unit La is not located in the optical path, and skwa represents the back focus at the wide angle end in a state where the aberration-changing lens unit La is located in the optical path.

The inequality (2) indicates a condition for obtaining an advantageous zoom lens in that picking up images with different video image representations can be switched without causing uncomfortable feeling.

When skwa/skw exceeds the upper and lower limits of the inequality (2), the change of the back focus becomes too large, and thus, when the video is switched, the video has a sense of strangeness in which the amount of blur is different.

In the zoom lens of each embodiment, it is preferable that the following condition is satisfied,

100≤|fa/fw| (3)

where fw represents a focal length of the zoom lens at the wide angle end when the aberration-changing lens unit La is not located in the optical path, and fa represents a focal length of the aberration-changing lens unit La.

The inequality (3) indicates a condition for obtaining a zoom lens which is advantageous in that the zoom lens is small in size but has the same image pickup magnification.

When the ratio |fa/fw| falls below the lower limit of the inequality (3), the change in the image pickup magnification becomes too large, resulting in an image of uncomfortable feeling when the image is switched. Alternatively, to largely change the principal point position of the aberration-changing lens unit La, the number of constituents of the aberration-changing lens unit La becomes too large, leading to a larger zoom lens.

In the zoom lens of each of the embodiments, it is preferable that the following condition is satisfied,

0.00≤|SAw/SAwa|≤0.20 (4)

where SAw represents a spherical aberration amount at 100 percent image-height beam ratio at the wide angle end in a state where the aberration-changing lens unit La is not located in the optical path, and SAwa represents a spherical aberration amount at the 100 percent image-height beam ratio at the wide angle end in a state where the aberration-changing lens unit La is located in the optical path.

Here, the spherical aberration amount at the 100 percent image-height beam ratio is the spherical aberration amount at the maximum effective diameter position, and is the spherical aberration amount (the value of the horizontal axis) at a position (a position of the maximum effective diameter) indicating the maximum value of the vertical axis in the spherical aberration diagram.

The inequality (4) indicates a condition for obtaining a zoom lens that is advantageous in that the image pickup with different video image representations can be switched without causing uncomfortable feeling. When the ratio |SAw/SAwa| exceeds the upper limit of the inequality (4), the change in aberration at the time of switching the video becomes too small, and it becomes difficult to perform imaging with different video image representations.

In the zoom lens of each embodiment, it is preferable that the following condition is satisfied,

−50.00≤Raf/Ra1≤−0.02 (5)

where Raf represents a curvature radius of a surface of the aberration-changing lens unit La closest to the object side and Ra1 represents a curvature radius of a surface of the aberration-changing lens unit La closest to the image side. Here, the signs of Raf and Ra1 are positive for a case of convex shape toward the object side and negative for a case of concave shape toward the object side.

The inequality (5) is a condition for obtaining a zoom lens which is advantageous in that, by setting the refractive powers of the front and rear surfaces of the aberration-changing lens unit La to the same sign, picking up images with different video image representations can be switched without causing uncomfortable feeling, while being small in size.

When Raf/Ra1 exceeds the upper and lower limits of the inequality (5), it becomes difficult to correct various aberrations, and thus it becomes difficult to perform picking up images with different video image representations. Alternatively, in order to correct various aberrations, the number of aberration-changing lens units La becomes too large, and the zoom lens becomes large.

In the zoom lens of each embodiment, it is preferable that the following condition is satisfied,

0.00≤|fw/fai|≤0.05 (6)

where fw represents a focal length of the zoom lens at the wide angle end when the aberration-changing lens unit La is not located in the optical path, and fai represents a focal length of the lens component having the strongest refractive power among lens components of the aberration-changing lens unit La. Here, the lens component refers to a single lens formed of one lens and a cemented lens formed by cementing a plurality of lenses to each other.

The inequality (6) defines the relationship between the focal length fw at the wide angle end and the focal length fai of the lens component having the strongest refractive power among the lens components of the aberration-changing lens unit La. Satisfying the inequality (6) provides an effect that the change of the image pickup magnification does not become too large or the zoom lens does not become too large.

In the zoom lens of each embodiment, it is preferable that the following condition is satisfied,

0.05≤Ndan−Ndap≤0.60 (7)

where Ndap represents an average refractive index of the positive lenses included in the aberration-changing lens unit La and Ndan represents an average refractive index of the negative lenses included in the aberration-changing lens unit La.

The inequality (7) defines the relationship between the average refractive index of the positive lenses included in the aberration-changing lens unit La and the average refractive index of the negative lenses included in the aberration-changing lens unit La. Satisfying the inequality (7) provides an effect that a change in the Petzval sum is reduced, and the uncomfortable feeling at the time of imaging due to a change in field curvature does not become too large or the zoom lens does not become too large.

In the zoom lens of each embodiment, it is preferable that the following condition is satisfied,

−0.10≤βr≤0.50 (8)

where βr represents a lateral magnification of the lens unit on the image side of the aberration-changing lens unit La in a state where the aberration-changing lens unit La is not located in the optical path.

The inequality (8) defines the lateral magnification of the lens unit closer to the image side than the aberration-changing lens unit La. When the inequality (8) is satisfied, it is possible to obtain an effect that various aberrations are corrected and the uncomfortable feeling at the time of picking up images does not become too large or the zoom lens does not become too large.

In the zoom lens of each embodiment, it is preferable that the following condition is satisfied,

0.00≤|SAw/fw|≤0.01 (9)

where SAw represents an amount of spherical aberration of the d-line at the 100 percent image-height beam ratio at the wide angle end in a state where the aberration-changing lens unit La is not located in the optical path, and fw represents a focal length of the zoom lens at the wide angle end in a state where the aberration-changing lens unit La is not located in the optical path.

The inequality (9) defines an amount of spherical aberration in a state where the aberration-changing lens unit La is not located in the optical path. When the inequality (9) is satisfied, it is possible to obtain an effect of easily recognizing different video image representations.

In the zoom lens of each embodiment, it is preferable that the following condition is satisfied,

0.01≤|SAwa/fwa|≤0.10 (10)

where SAwa represents an amount of spherical aberration of the d-line at the 100 percent image-height beam ratio at the wide angle end in a state where the aberration-changing lens unit La is located in the optical path, and fwa represents a focal length of the zoom lens at the wide angle end in a state where the aberration-changing lens unit La is located in the optical path.

The inequality (10) defines the amount of spherical aberration in a state where the aberration-changing lens unit La is located in the optical path. When the inequality (10) is satisfied, it is possible to obtain an effect of easily recognizing different video image representations.

It is more preferable that the numerical ranges of the inequalities (1) to (10) are as follows.

0.90≤fwa/fw≤1.10 (1a)

0.97≤skwa/skw≤1.03 (2a)

500≤|fa/fw| (3a)

0.01≤|SAw/SAwa|≤0.15 (4a)

−40.00≤Raf/Ra1≤−0.10 (5a)

0.001≤|fw/fai|≤0.045 (6a)

0.08≤Ndan−Ndap≤0.58 (7a)

0.00≤βr≤0.45 (8a)

0.00≤|SAw/fw|≤0.007 (9a)

0.015≤|SAwa/fwa|≤0.09 (10a)

It is more preferable that the numerical ranges of the inequalities (1a) to (10a) be as follows.

0.95≤fwa/fw≤1.05 (1b)

0.99≤skwa/skw≤1.01 (2b)

1000≤|fa/fw| (3b)

0.05≤|SAw/SAwa|≤0.13 (4b)

−30.00≤Raf/Ra1≤−0.20 (5b)

0.002≤|fw/fai|≤0.040 (6b)

0.09≤Ndan−Ndap≤0.57 (7b)

0.01≤βr≤0.40 (8b)

0.00≤|SAw/fw|≤0.005 (9b)

0.02≤|SAwa/fwa|≤0.07 (10b)

Hereinafter, the zoom lenses according to Embodiments 1 to 8 will be specifically described.

### Embodiment 1

The zoom lens according to Embodiment 1 will be described with reference to FIGS. 1 to 4C.

FIG. 1 is a cross-sectional view of the zoom lens according to Embodiment 1 in a state where the aberration-changing lens unit La is located at a position retracted from the optical path and is not located on the optical path when focusing on infinity at the wide angle end.

The zoom lens of Embodiment 1 includes, in order from the object side to the image side, a first lens unit L1 having a positive refractive power, a second lens unit L2 having a negative refractive power, a third lens unit L3 having a negative refractive power, a fourth lens unit L4 having a positive refractive power, an aperture stop SP, and a rear lens unit LR having a positive refractive power.

I represents the image plane. An imaging surface (light receiving surface) of the image pickup element and a film surface (photosensitive surface) of the silver halide film are disposed on the image plane I. A glass block P such as a prism or an optical filter is disposed between the zoom lens and the image plane I.

During zooming, an interval between the lens units adjacent to each other changes. During zooming from the wide angle end to the telephoto end, the first lens unit L1 and the rear lens unit LR do not move in the optical axis direction with respect to the image plane, the second lens unit L2 moves monotonously toward the image side, the third lens unit L3 moves along a locus of a convex shape toward the object side, and the fourth lens unit L4 moves non-monotonically. During focusing (focus adjustment) from a long-distance object to a short-distance object, all or part of the first lens unit L1 moves in the optical axis direction.

The first lens unit L1 includes, in order from the object side to the image side, a negative lens, a positive lens, a positive lens, a meniscus positive lens convex to the object side, a positive lens, and a meniscus positive lens convex to the object side, and corresponds to the first surface to the twelfth surface in a numerical embodiment described later.

The second lens unit L2 is composed of, in order from the object side to the image side, a negative meniscus lens convex to the object side, a cemented lens composed of a negative meniscus lens concave to the object side, a convex lens, and a negative meniscus lens concave to the object side, and a positive lens. In the numerical embodiment, the second lens unit L2 corresponds to a thirteenth surface to the twentieth surface, and the thirteenth surface is an aspherical surface.

The third lens unit L3 includes, in order from the object side to the image side, a cemented lens composed of a negative lens and a positive lens. In the numerical embodiment, the third lens unit L3 corresponds to the twenty-first surface to the twenty-third surface.

The fourth lens unit L4 includes, in order from the object side to the image side, a positive lens, and a cemented lens composed of a meniscus negative lens convex to the object side and a meniscus positive lens convex to the object side. In the numerical embodiment, the fourth lens unit L4 corresponds to the twenty-fourth surface to the twenty-eighth surface, and the twenty-fifth surface is an aspherical surface.

The aperture stop SP corresponds to the twenty-ninth surface.

The rear lens unit LR includes, in order from the object side to the image side, a cemented lens composed of a meniscus positive lens concave to the object side and a negative lens, (insertion/removal position), a positive lens, a cemented lens composed of a meniscus negative lens convex to the object side and a positive lens, a cemented lens composed of a positive lens and a meniscus negative lens concave to the object side, and a positive lens.

Here, the insertion/removal position is a position where the aberration-changing lens unit La is inserted/removed into/from the optical path. In the numerical embodiment (in a state in which the aberration-changing lens unit La is not located in the optical path), the rear lens unit LR corresponds to the thirtieth surface to the forty-second surface. Here, since the surface number of the rear lens unit LR is a number in a state in which the aberration-changing lens unit La described later is not inserted into the optical path in the rear lens unit LR, the surface number changes in the embodiment described later in which the aberration-changing lens unit La is inserted into the rear lens unit LR.

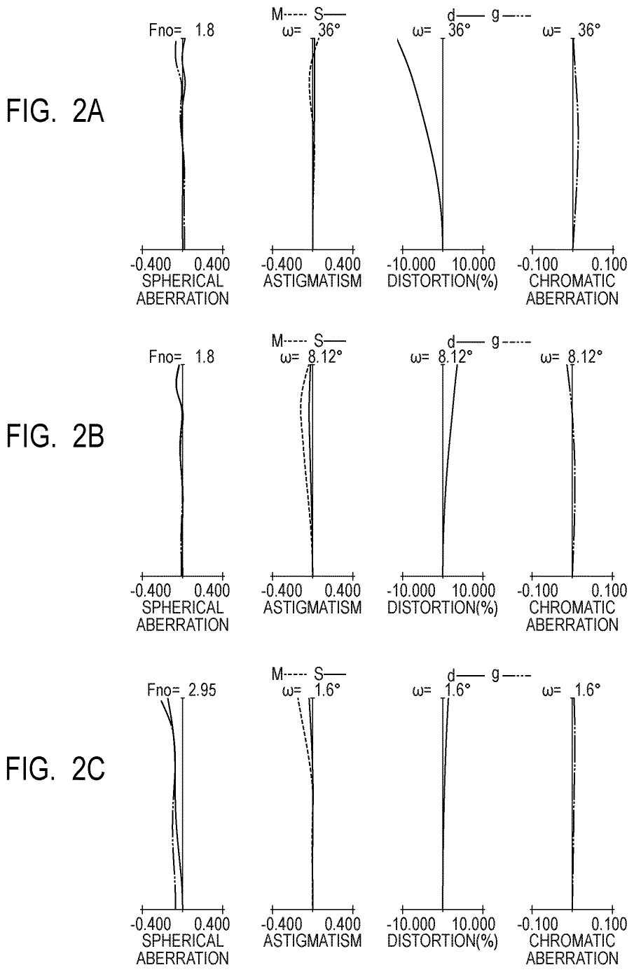

FIGS. 2A, 2B, and 2C are aberration diagrams of the zoom lens of Embodiment 1 at the wide angle end, the intermediate zoom position, and the telephoto end when focusing on infinity in a state where the aberration-changing lens unit La is not located in the optical path.

The spherical aberration diagram shows spherical aberration of d-line (wavelength: 587.6 nm) and the g-line (wavelength: 435.8 nm) by a solid line and a two-dot chain line, respectively. The astigmatism diagram shows astigmatism at the meridional image surface and the sagittal image surface by a broken line and a solid line, respectively. The distortion diagram shows distortion of the d-line. In the chromatic aberration diagram, the two-dot chain line indicates the chromatic aberration of magnification at the g-line.

Fno represents an F number, and ω represents a half angle of view (degrees). The full scale of the horizontal axis of the spherical aberration diagram is ±0.400 mm, and the full scale of the horizontal axis of the astigmatism diagram is also ±0.400 mm. The full scale of the horizontal axis of the distortion diagram is ±10.000%. The full scale of the horizontal axis of the chromatic aberration diagram is ±0.100 mm. The above description of the aberration diagrams is the same in other numerical embodiments to be described later.

Note that the configuration and aberration diagrams of the zoom lens of Embodiment 1 in a state where the aberration-changing lens unit La is not located in the optical path, which are illustrated in FIGS. 1, 2A, 2B, and 2C, are the same in Embodiments 2 to 7, and thus description thereof is omitted in Embodiments 2 to 7. The zoom lens of the present disclosure may employ mechanisms such as a turret to move the aberration-correcting lens unit La between insertion/retraction positions and switch between the retracted state and the deployed state. However, the present disclosure is not limited to this mechanism; any switchable configuration is acceptable.

The zoom lens of Embodiment 1 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 3) and a state in which the aberration-changing lens unit La is not located in the optical path (FIG. 1) by inserting and removing the aberration-changing lens unit La into and from the optical path, it is possible to perform picking up images with different video image representations.

FIG. 3 is a cross-sectional view of the zoom lens according to Embodiment 1 at the time of focusing on infinity at the wide angle end in a state in which the aberration-changing lens unit La is located at the insertion/removal position of the optical path. FIG. 3 is a cross-sectional view illustrating a state in which the aberration-changing lens unit La according to Embodiment 1 is disposed at the insertion/removal position in the retracted state illustrated in FIG. 1.

The aberration-changing lens unit La in the zoom lens of Embodiment 1 has a weak negative refractive power, and is composed of a cemented lens composed of a positive lens and a negative lens and a meniscus positive lens concave to the object side that are arranged in order from the object side to the image side. The aberration-changing lens unit La in Embodiment 1 shown in FIG. 3 corresponds to the thirty-third surface to the thirty-seventh surface.

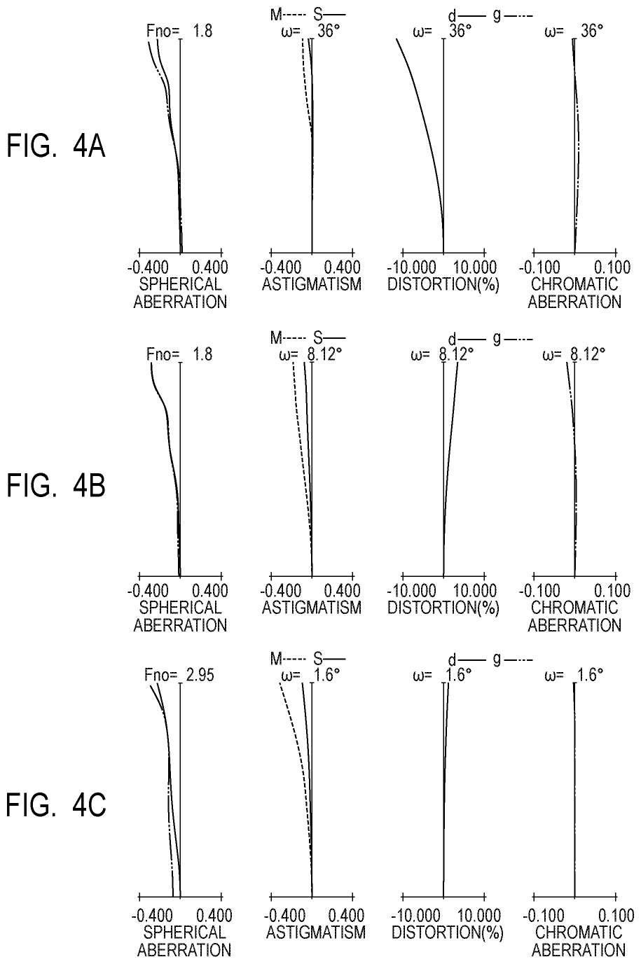

FIGS. 4A, 4B, and 4C show longitudinal aberration diagrams (spherical aberration, astigmatism, distortion, and chromatic aberration) at the wide angle end, the intermediate zoom position, and the telephoto end when focusing on infinity in a state where the aberration-changing lens unit La is located at the insertion/removal position of the optical path of the zoom lens of Embodiment 1.

Comparing the aberration diagrams of FIGS. 2A, 2B, and 2C the aberration diagrams of FIGS. 4A, 4B, and 4C reveals a remarkable difference in the spherical aberration in particular at any of the wide angle end, the intermediate zoom position, and the telephoto end. This demonstrates that inserting and extracting the aberration-changing lens unit La into and from the optical path enables picking up images with different video image representations.

The values corresponding to the inequalities (1) to (10) in Embodiment 1 are summarized in Table 1. The zoom lens of Embodiment 1 satisfies all the inequalities (1) to (10), and enables picking up images with the same image pickup magnification and different video image representations while being small in size.

### Embodiment 2

A zoom lens of Embodiment 2 will be described with reference to FIGS. 1, 2A, 2B, 2C, 5, 6A, 6B and 6C.

Since the cross-sectional view and the aberration diagram of the zoom lens of Embodiment 2 in the retracted state are the same as the cross-sectional view and the aberration diagram of Embodiment 1 described with reference to FIGS. 1, 2A, 2B, and 2C, the description thereof will be omitted here.

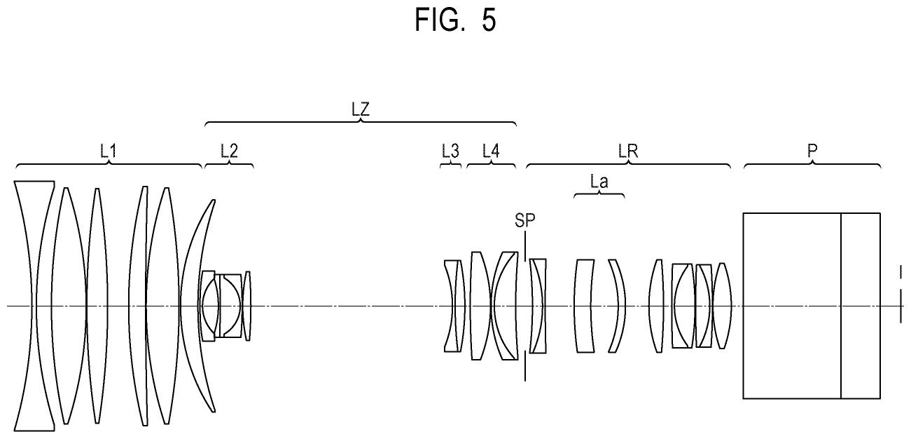

The zoom lens of Embodiment 2 includes an aberration-changing lens unit La configured to be insertable into and removable from the optical path (insertion/removal position) between the frontmost surface and the rearmost surface of the lenses constituting the rear lens unit LR. By switching between a state in which the aberration-changing lens unit La is located in the optical path (FIG. 5) and a state in which the aberration-changing lens unit La is not located in the optical path (FIG. 1) by inserting and removing the aberration-changing lens unit La into and from the optical path, it is possible to perform picking up images with different video image representations.

FIG. 5 is a cross-sectional view of the zoom lens according to the second embodiment when focusing on infinity at the wide angle end in a state in which the aberration-changing lens unit La is located at the insertion/removal position of the optical path. FIG. 5 is a cross-sectional view illustrating a state in which the aberration-changing lens unit La according to Embodiment 2 is disposed at the insertion/removal position in the retracted state illustrated in FIG. 1.

The aberration-changing lens unit La in the zoom lens of Embodiment 2 has a weak negative refractive power, and is composed of a meniscus negative lens convex to the object side and a meniscus positive lens concave to the object side, which are arranged in order from the object side to the image side. The aberration-changing lens unit La in Embodiment 2 corresponds to the thirty-third surface to the thirty-sixth surface.

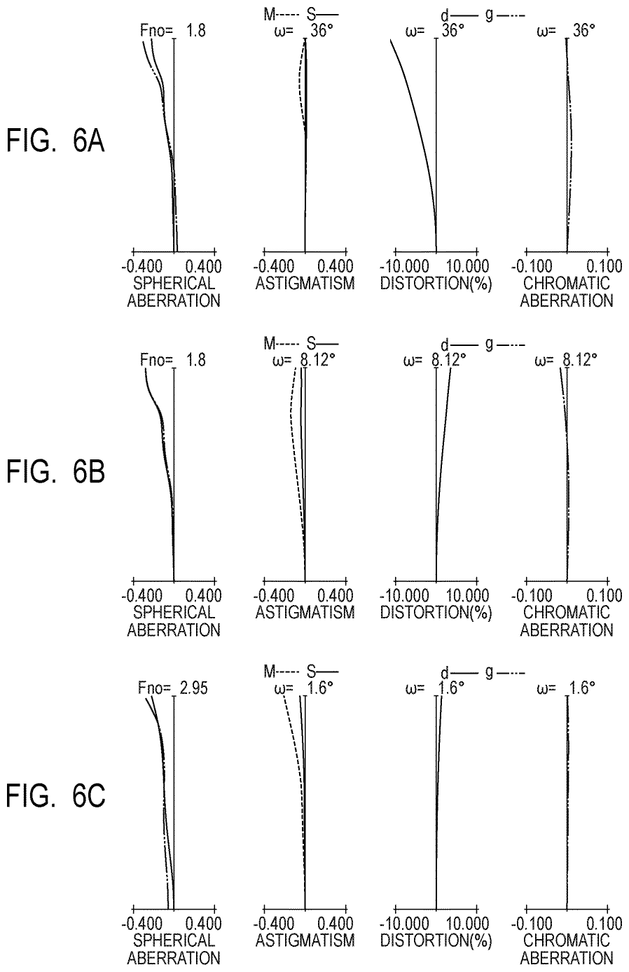

FIGS. 6A, 6B, and 6C show longitudinal aberration diagrams at the wide angle end, the intermediate zoom position, and the telephoto end, respectively, when focusing on infinity in a state where the aberration-changing lens unit La is disposed at the insertion/removal position of the optical path of the zoom lens of Embodiment 2.

Comparing the aberration diagrams of FIGS. 2A, 2B, and 2C with the aberration diagrams of FIGS. 6A, 6B, and 6C reveals a remarkable difference in the spherical aberration, in particular, at any of the wide angle end, the intermediate zoom position, and the telephoto end. This demonstrates that inserting and removing the aberration-changing lens unit La into and from the optical path enables picking up images with different video image representations.

The values corresponding to the inequalities (1) to (10) in Embodiment 2 are summarized in Table 1. The zoom lens of Embodiment 2 satisfies all the inequalities (1) to (10), and enables; picking up images with the same imaging magnification and different video image representations while being small in size.

### Embodiment 3

A zoom lens of Embodiment 3 will be described with reference to FIGS. 1, 2A, 2B, 2C, 7, 8A, 8B and 8C.

Since the cross-sectional view and the aberration diagram of the zoom lens of Embodiment 3 in the retracted state are the same as the cross-sectional view and the aberration diagram of Embodiment 1 described with reference to FIGS. 1, 2A, 2B, and 2C, the description thereof will be omitted here.

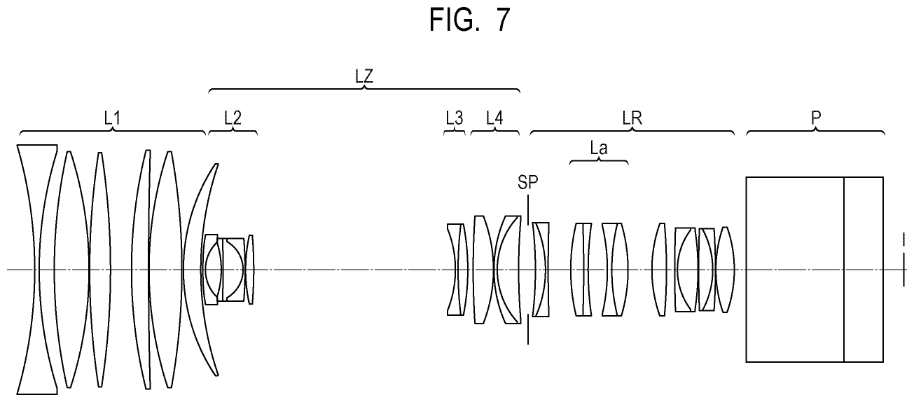

The zoom lens of Embodiment 3 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 7) and a state in which the aberration-changing lens unit La is not located in the optical path (FIG. 1) by inserting and removing the aberration-changing lens unit La into and from the optical path, it is possible to perform picking up images with different video image representations.

FIG. 7 is a cross-sectional view of the zoom lens according to Embodiment 3 when focusing on infinity at the wide angle end in a state in which the aberration-changing lens unit La is disposed. FIG. 7 is a cross-sectional view illustrating a state in which the aberration-changing lens unit La of Embodiment 3 is disposed at the insertion/removal position in the retracted state illustrated in FIG. 1.

The aberration-changing lens unit La in the zoom lens of Embodiment 3 has a weak negative refractive power, and is composed of a cemented lens composed of a positive lens and a negative lens, and a cemented lens composed of a negative lens and a positive lens, which are arranged in order from the object side to the image side. The aberration-changing lens unit La in Embodiment 3 corresponds to the thirty-third surface to the thirty-eighth surface.

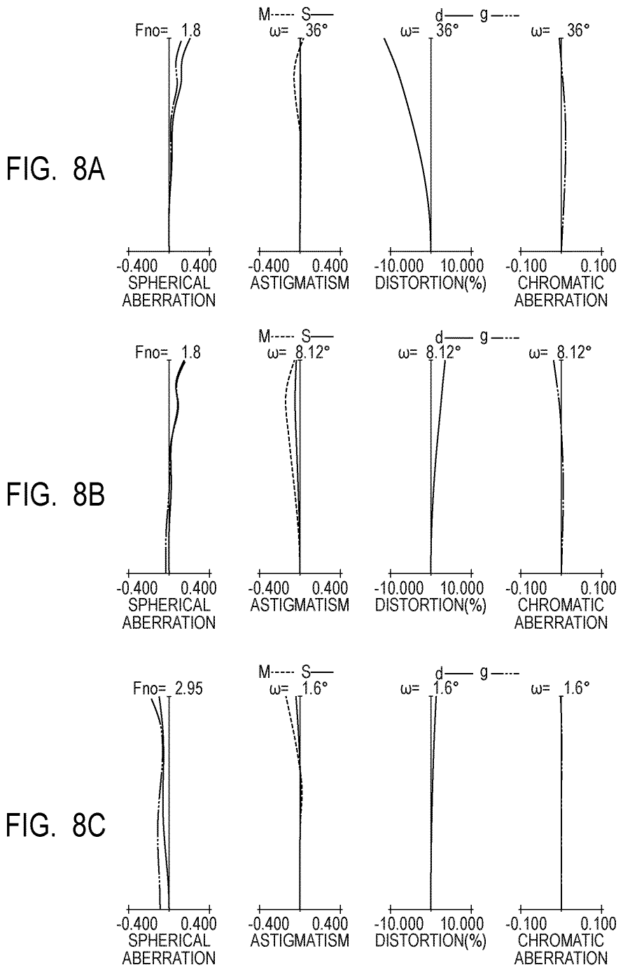

FIGS. 8A, 8B, and 8C are longitudinal aberration diagrams at the wide angle end, the intermediate zoom position, and the telephoto end, respectively, when focusing on infinity in a state where the aberration-changing lens unit La is disposed at the insertion/removal position of the optical path of the zoom lens of Embodiment 3.

Comparing the aberration diagrams of FIGS. 2A, 2B, and 2C with the aberration diagrams of FIGS. 8A, 8B, and 8C reveals a remarkable difference in the spherical aberration, in particular, at any of the wide angle end, the intermediate zoom position, and the telephoto end. This demonstrates inserting and extracting the aberration-changing lens unit La into and from the optical path enables picking up images with different video image representations.

The values corresponding to the inequalities (1) to (10) in Embodiment 3 are summarized in Table 1. The zoom lens of Embodiment 3 satisfies all the inequalities (1) to (10), and enables picking up images with the same imaging magnification and different video image representations while being small in size.

### Embodiment 4

A zoom lens of Embodiment 4 will be described with reference to FIGS. 1, 2A, 2B, 2C, 9, 10A, 10B and 10C.

Since the cross-sectional view and the aberration diagram of the zoom lens of Embodiment 4 in the retracted state are the same as the cross-sectional view and the aberration diagram of Embodiment 1 described with reference to FIGS. 1, 2A, 2B, and 2C, the description thereof will be omitted here.

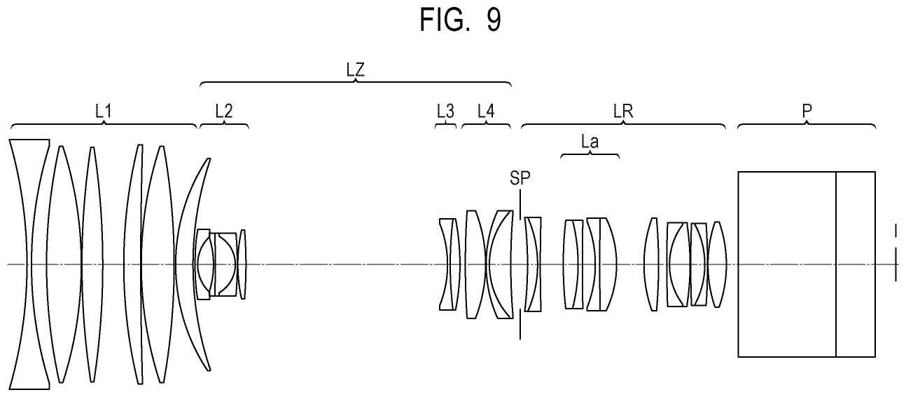

The zoom lens of Embodiment 4 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 9) and a state in which the aberration-changing lens unit La is not located in the optical path (FIG. 1) by inserting and removing the aberration-changing lens unit La into and from the optical path, it is possible to perform picking up images with different video image representations.

FIG. 9 is a cross-sectional view of the zoom lens according to Embodiment 4 at the time of focusing on infinity at the wide angle end in a state in which the aberration-changing lens unit La is disposed. FIG. 9 is a cross-sectional view illustrating a state in which the aberration-changing lens unit La of Embodiment 4 is disposed at the insertion/removal position in the retracted state illustrated in FIG. 1.

The aberration-changing lens unit La in the zoom lens of Embodiment 4 has weak positive refractive power, and is composed of a cemented lens composed of a positive lens and a negative lens, and a cemented lens composed of a negative lens and a positive lens, which are arranged in order from the object side to the image side. The aberration-changing lens unit La in Embodiment 4 corresponds to the thirty-third surface to the thirty-eighth surface.

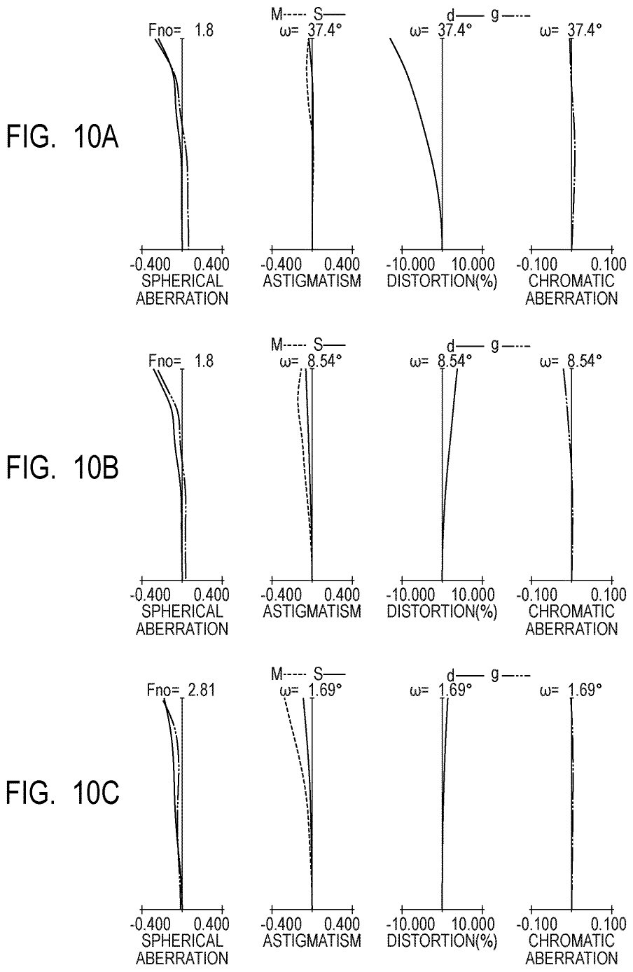

FIGS. 10A, 10B, and 10C show longitudinal aberration diagrams at the wide angle end, the intermediate zoom position, and the telephoto end, respectively, at the time of focusing on infinity in a state where the aberration-changing lens unit La is disposed at the insertion/removal position of the optical path of the zoom lens of Embodiment 4.

Comparing the aberration diagrams of FIGS. 2A, 2B, and 2C with the aberration diagrams of FIGS. 10A, 10B, and 10C reveals a remarkable difference in the spherical aberration in particular at any of the wide angle end, the intermediate zoom position, and the telephoto end. This demonstrates inserting and extracting the aberration-changing lens unit La into and from the optical path enables picking up images with different video image representations.

The values corresponding to the inequalities (1) to (10) in Embodiment 4 are summarized in Table 1. The zoom lens of Embodiment 4 satisfies all the inequalities (1) to (10), and enables picking up images with the same imaging magnification and different video image representations while being small in size.

### Embodiment 5

A zoom lens of Embodiment 5 will be described with reference to FIGS. 1, 2A, 2B, 2C, 11, 12A, 12B and 12C.

Since the cross-sectional view and the aberration diagram of the zoom lens of Embodiment 5 in the retracted state are the same as the cross-sectional view and the aberration diagram of Embodiment 1 described with reference to FIGS. 1, 2A, 2B, and 2C, the description thereof will be omitted here.

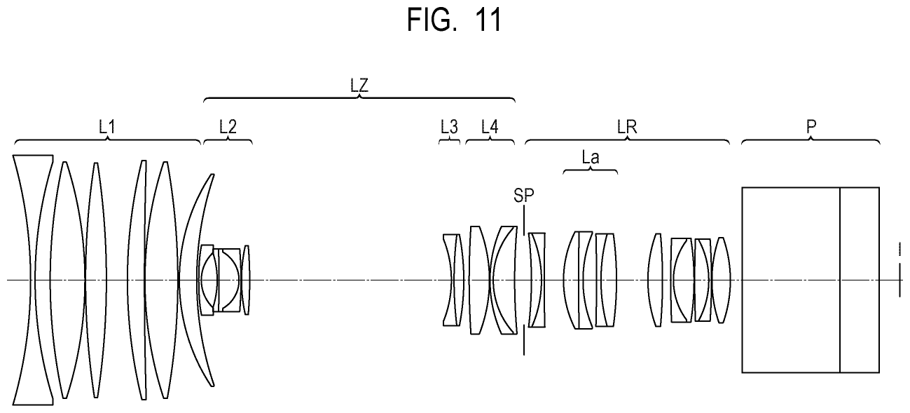

The zoom lens of Embodiment 5 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 11) and a state in which the aberration-changing lens unit La is not located in the optical path (FIG. 1) by inserting and removing the aberration-changing lens unit La into and from the optical path, it is possible to perform picking up images with different video image representations.

FIG. 11 is a cross-sectional view of the zoom lens according to Embodiment 5 at the time of focusing on infinity at the wide angle end in a state in which the aberration-changing lens unit La is disposed. FIG. 11 is a cross-sectional view illustrating a state in which the aberration-changing lens unit La of Embodiment 5 is disposed at the insertion/removal position in the retracted state illustrated in FIG. 1.

The aberration-changing lens unit La in the zoom lens of Embodiment 5 has a weak negative refractive power, and is composed of a cemented lens composed of a meniscus positive lens convex to the object side and a meniscus negative lens convex to the object side, and a cemented lens composed of a negative lens and a positive lens, which are arranged in order from the object side to the image side. The aberration-changing lens unit La in Embodiment 5 corresponds to the thirty-third surface to the thirty-eighth surface.

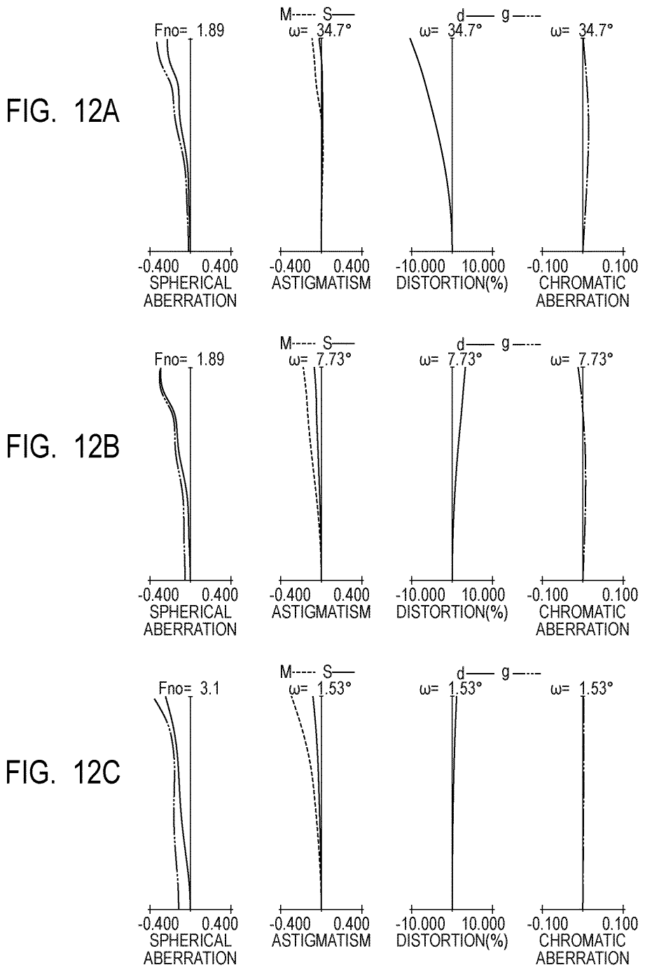

FIGS. 12A, 12B, and 12C show longitudinal aberration diagrams at the wide angle end, the intermediate zoom position, and the telephoto end, respectively, at the time of focusing on infinity in a state where the aberration-changing lens unit La is disposed at the insertion/removal position in the optical path of the zoom lens of Embodiment 5.

Comparing the aberration diagrams of FIGS. 2A, 2B, and 2C with the aberration diagrams of FIGS. 12A, 12B, and 12C reveals a remarkable difference in the spherical aberration in particular at any of the wide angle end, the intermediate zoom position, and the telephoto end. This demonstrates inserting and extracting the aberration-changing lens unit La into and from the optical path enables picking up images with different video image representations.

The values corresponding to the inequalities (1) to (10) in Embodiment 5 are summarized in Table 1. The zoom lens of Embodiment 5 satisfies all the inequalities (1) to (10), and enables picking up images with the same imaging magnification and different video image representations while being small in size.

### Embodiment 6

A zoom lens of Embodiment 6 will be described with reference to FIGS. 1, 2A, 2B, 2C, 13, 14A, 14B and 14C.

Since the cross-sectional view and the aberration diagram of the zoom lens of Embodiment 6 in the retracted state are the same as the cross-sectional view and the aberration diagram of Embodiment 1 described with reference to FIGS. 1, 2A, 2B, and 2C, the description thereof will be omitted here.

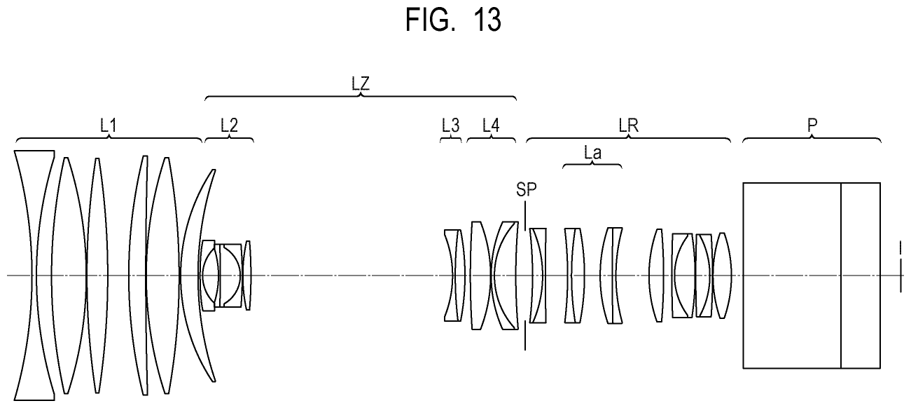

The zoom lens of Embodiment 6 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 13) and a state in which the aberration-changing lens unit La is not located in the optical path (FIG. 1) by inserting and removing the aberration-changing lens unit La into and from the optical path, it is possible to perform picking up images with different video image representations.

FIG. 13 is a cross-sectional view of the zoom lens according to Embodiment 6 at the time of focusing on infinity at the wide angle end in a state in which the aberration-changing lens unit La is disposed. FIG. 13 is a cross-sectional view illustrating a state in which the aberration-changing lens unit La of Embodiment 6 is disposed at the insertion/removal position in the retracted state illustrated in FIG. 1.

The aberration-changing lens unit La in the zoom lens of Embodiment 6 has a weak negative refractive power, and is composed of a cemented lens composed of a negative lens and a positive lens, and a cemented lens composed of a meniscus positive lens convex to the object side and a meniscus negative lens convex to the object side, which are arranged in order from the object side to the image side. The aberration-changing lens unit La in Embodiment 6 corresponds to the thirty-third surface to the thirty-eighth surface.

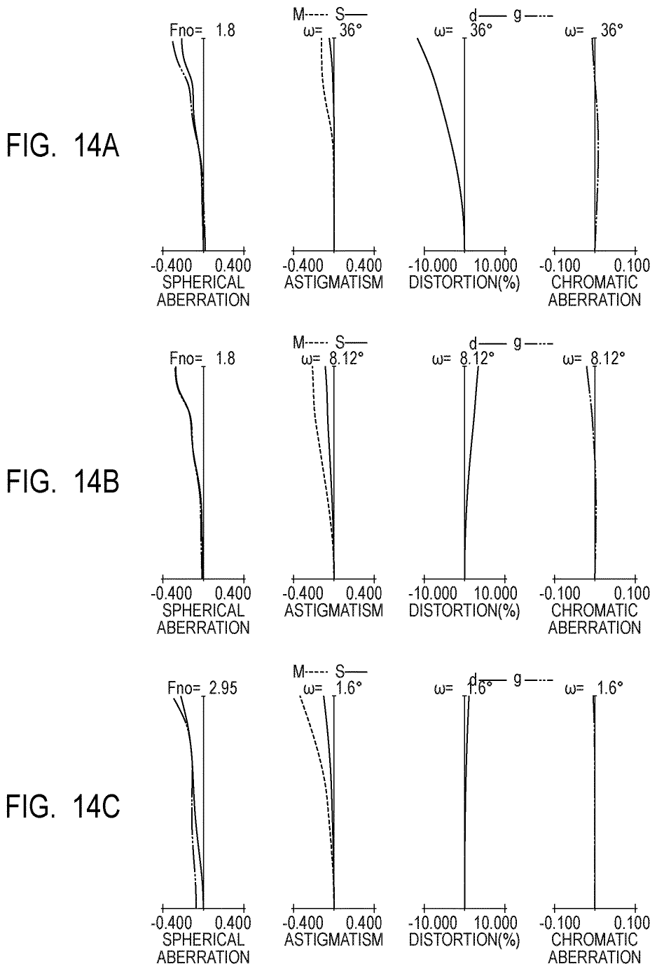

FIGS. 14A, 14B, and 14C show longitudinal aberration diagrams at the wide angle end, the intermediate zoom position, and the telephoto end, respectively, at the time of focusing on infinity in a state where the aberration-changing lens unit La is disposed at the insertion/removal position in the optical path of the zoom lens of Embodiment 6.

Comparing the aberration diagrams of FIGS. 2A, 2B, and 2C with the aberration diagrams of FIGS. 14A, 14B, and 14C reveals a remarkable difference in the spherical aberration in particular at any of the wide angle end, the intermediate zoom position, and the telephoto end. This demonstrates inserting and extracting the aberration-changing lens unit La into and from the optical path enables picking up images with different video image representations.

The values corresponding to the inequalities (1) to (10) in Embodiment 6 are summarized in Table 1. The zoom lens of Embodiment 6 satisfies all the inequalities (1) to (10), and enables picking up images with the same imaging magnification and different video image representations while being small in size.

### Embodiment 7

A zoom lens of Embodiment 7 will be described with reference to FIGS. 1, 2A, 2B, 2C, 15, 16A, 16B and 16C.

Since the cross-sectional view and the aberration diagram of the zoom lens of Embodiment 7 in the retracted state are the same as the cross-sectional view and the aberration diagram of Embodiment 1 described with reference to FIGS. 1, 2A, 2B, and 2C, the description thereof will be omitted here.

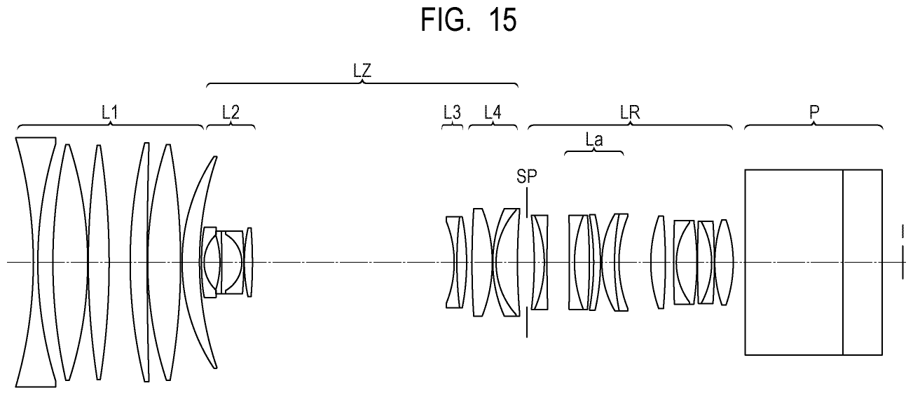

The zoom lens of Embodiment 7 includes an aberration-changing lens unit La configured to be insertable into and removable from an optical path (insertion/removal position) between the frontmost surface and the rearmost surface of the lenses constituting the rear lens unit LR. By switching between a state in which the aberration-changing lens unit La is located in the optical path (FIG. 15) and a state in which the aberration-changing lens unit La is not located in the optical path (FIG. 1) by inserting and removing the aberration-changing lens unit La into and from the optical path, it is possible to perform picking us images with different video image representations.

FIG. 15 is a cross-sectional view of the zoom lens according to Embodiment 7 when focusing on infinity at the wide angle end in a state in which the aberration-changing lens unit La is disposed. FIG. 15 is a cross-sectional view illustrating a state in which the aberration-changing lens unit La of Embodiment 7 is disposed at the insertion/removal position in the retracted state illustrated in FIG. 1.

The aberration-changing lens unit La according to Embodiment 7 has a weak negative refractive power and is composed of a cemented lens composed of a negative lens and a positive lens, a meniscus positive lens concave to the object side, and a cemented lens composed of a meniscus positive lens convex to the object side and a meniscus negative lens convex to the object side, which are arranged in order from the object side to the image side. The aberration-changing lens unit La in Embodiment 7 corresponds to the thirty-third surface to the fortieth surface.

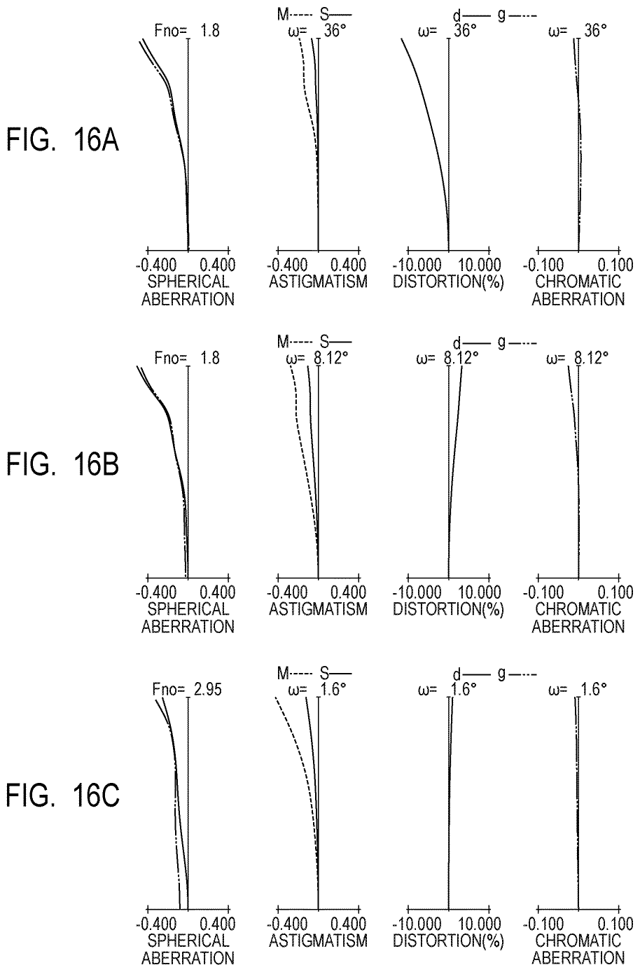

FIGS. 16A, 16B, and 16C show longitudinal aberration diagrams at the wide angle end, the intermediate zoom position, and the telephoto end, respectively, at the time of focusing on infinity in a state where the aberration-changing lens unit La is disposed at the insertion/removal position of the optical path of the zoom lens of Embodiment 7.

Comparing the aberration diagrams of FIGS. 2A, 2B, and 2C with the aberration diagrams of FIGS. 16A, 16B, and 16C reveals a remarkable difference in the spherical aberration, in particular, at any of the wide angle end, the intermediate zoom position, and the telephoto end. This demonstrates inserting and extracting the aberration-changing lens unit La into and from the optical path enables picking up images with different video image representations.

The values corresponding to the inequalities (1) to (10) in Embodiment 7 are summarized in Table 1. The zoom lens of Embodiment 7 satisfies all the inequalities (1) to (10), and enables picking up images with the same imaging magnification and different video image representations while being small in size.

### Embodiment 8

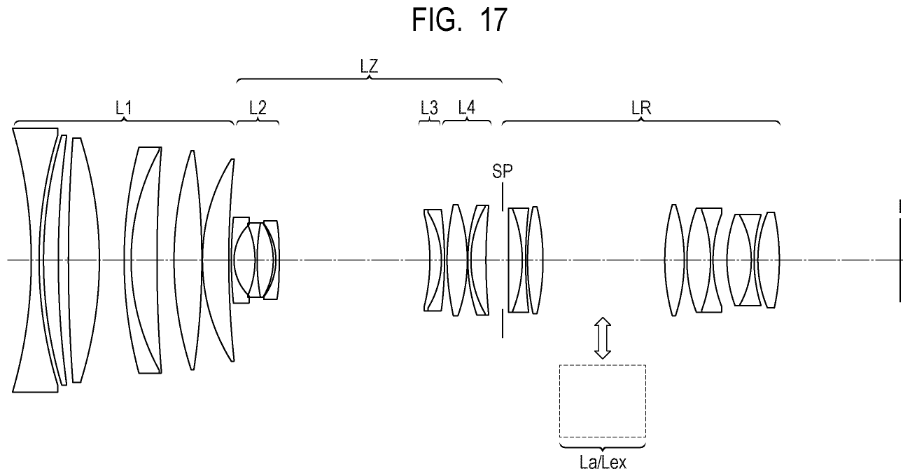

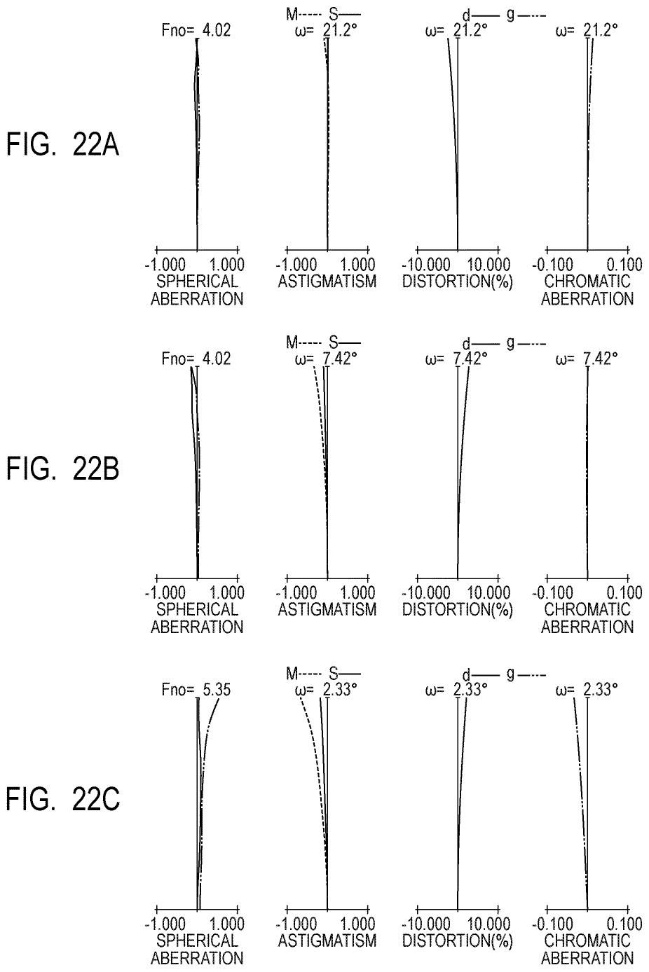

A zoom lens of Embodiment 8 will be described with reference to FIGS. 17 to 22C.

The zoom lens of Embodiment 8 differs from the zoom lenses of Embodiments 1 to 7 in which the aberration-changing lens unit La can be inserted into and removed from the optical path of the rear lens unit LR, whereas the aberration-changing lens unit La and an extender lens unit Lex can be selectively inserted into and removed from the optical path of the rear lens unit LR.

FIG. 17 is a cross-sectional view of the zoom lens of Embodiment 8 in a state (retracted state) in which both the aberration-changing lens unit La and the extender lens unit Lex are in the retracted position and are not located in the optical path, at the time of focusing on infinity at the wide angle end.

The zoom lens of Embodiment 8 includes, in order from the object side to the image side, a first lens unit L1 having a positive refractive power, a second lens unit L2 having a negative refractive power, a third lens unit L3 having a negative refractive power, a fourth lens unit L4 having a positive refractive power, an aperture stop SP, and a rear lens unit LR having a positive refractive power.

During zooming, an interval between the lens units adjacent to each other changes. During zooming from the wide angle end to the telephoto end, the first lens unit L1 and the rear lens unit LR do not move in the optical axis direction with respect to the image plane, the second lens unit L2 moves monotonously toward the image side, the third lens unit L3 moves along a locus of a convex shape to the object side, and the fourth lens unit L4 moves non-monotonically. During focusing (focus adjustment) from a long-distance object to a short-distance object, all or part of the first lens unit L1 moves in the optical axis direction.

The first lens unit L1 includes, in order from the object side to the image side, a negative lens, a meniscus positive lens convex to the object side, a positive lens, a cemented lens composed of a meniscus negative lens convex to the object side and a meniscus positive lens convex to the object side, a positive lens, and a meniscus positive lens convex to the object side. The first lens unit L1 corresponds to the first surface to the thirteenth surface in Numerical Embodiment 8 described later, and the sixth surface is an aspherical surface.

The second lens unit L2 is composed of a meniscus negative lens convex to the object side, a cemented lens composed of a negative lens and a positive lens, and a meniscus negative lens concave to the object side, which are arranged in order from the object side to the image side. As shown in Numerical Embodiment 8 described later, the second lens unit L2 corresponds to a fourteenth surface to a twentieth surface, and the twentieth surface is an aspherical surface.

The third lens unit L3 includes, in order from the object side to the image side, a cemented lens composed of a meniscus positive lens concave to the object side and a meniscus negative lens concave to the object side. In Numerical Embodiment 8 described later, the third lens unit L3 corresponds to the twenty-first surface to the twenty-third surface.

The fourth lens unit L4 is composed of a positive lens, a cemented lens composed of a meniscus negative lens convex to the object side and a meniscus positive lens convex to the object side, which are arranged in order from the object side to the image side. In the numerical embodiment, the fourth lens unit L4 corresponds to a twenty-fourth surface to a twenty-eighth surface, and the twenty-fourth surface is an aspherical surface.

The aperture stop SP corresponds to the twenty-ninth surface.

The rear lens unit LR includes, in order from the object side to the image side, a cemented lens formed of a meniscus positive lens concave to the object side and a negative lens, a positive lens, (the insertion/removal position), a positive lens, a cemented lens formed of a positive lens and a negative lens, a cemented lens formed of a positive lens and a negative lens, and a positive lens. Here, the insertion/removal position is a position where the aberration-changing lens unit La and/or the extender lens unit Lex are/is inserted into or removed from the optical path. In Numerical Embodiment 8 described later (in a state where the aberration-changing lens unit La and the extender lens unit Lex are not disposed in the optical path), the rear lens unit LR corresponds to the thirtieth surface to the forty-fourth surface.

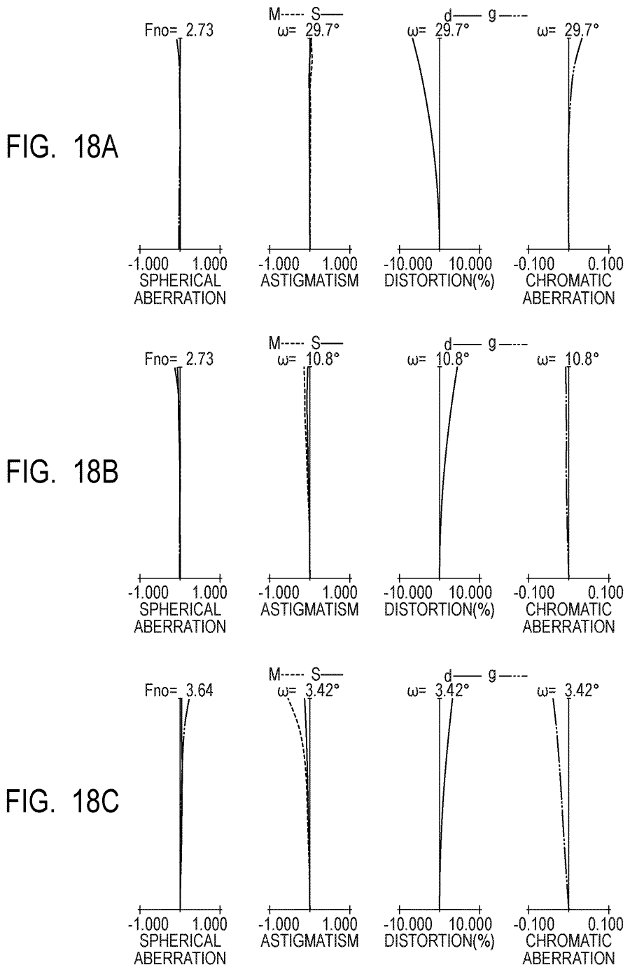

FIGS. 18A, 18B, and 18C are aberration diagrams of the zoom lens of Embodiment 8 at the wide angle end, the intermediate zoom position, and the telephoto end, respectively, at the time of focusing on infinity in a state where the aberration-changing lens unit La and the extender lens unit Lex are not disposed in the optical path.

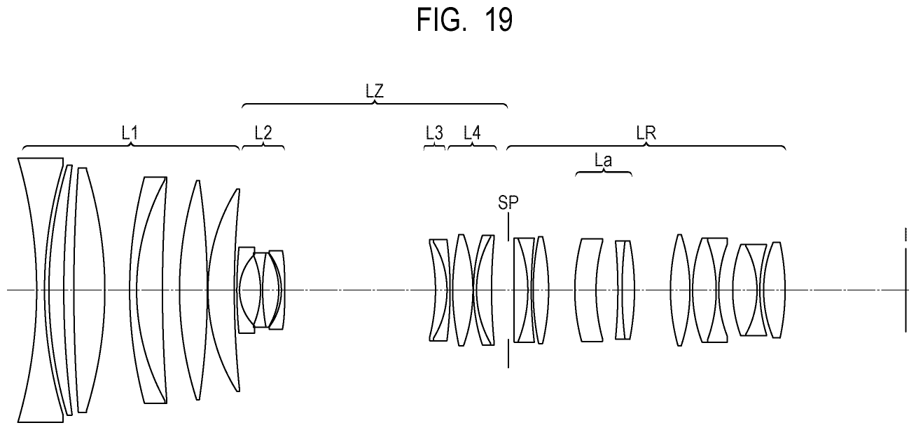

FIG. 19 is a cross-sectional view of the zoom lens according to Embodiment 8 in a state where the aberration-changing lens unit La is disposed at the insertion/removal position in the optical path and in a state of focusing on infinity at the wide angle end. FIG. 19 is a cross-sectional view illustrating a state in which the aberration-changing lens unit La of Embodiment 8 is disposed at the insertion/removal position in the retracted state illustrated in FIG. 17.

The aberration-changing lens unit La in the zoom lens of Embodiment 8 has a weak negative refractive power, and is composed of a meniscus negative lens convex to the object side, and a cemented lens composed of a negative lens and a positive lens, which are arranged in order from the object side to the image side. The aberration-changing lens unit La in Embodiment 8 corresponds to the thirty-fifth surface to the thirty-ninth surface.

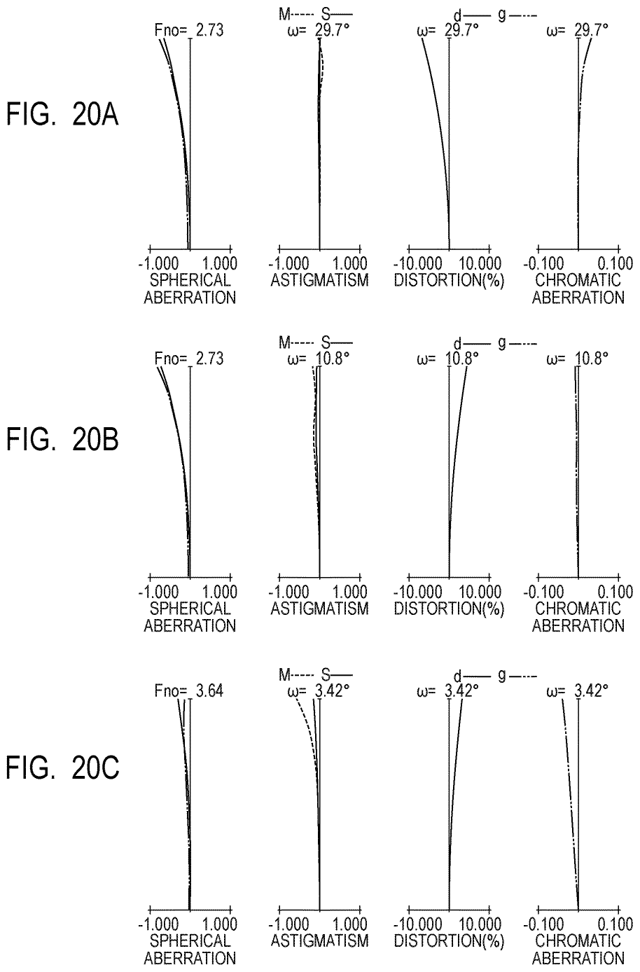

FIGS. 20A, 20B, and 20C are longitudinal aberration diagrams at the wide angle end, the intermediate zoom position, and the telephoto end, respectively, at the time of focusing on infinity in a state where the aberration-changing lens unit La of the zoom lens of Embodiment 8 is disposed in the optical path.

Comparing the aberration diagrams of FIGS. 18A, 18B, and 18C with the aberration diagrams of FIGS. 20A, 20B, and 20C reveals a remarkable difference in the spherical aberration in particular at any of the wide angle end, the intermediate zoom position, and the telephoto end. This demonstrates inserting and extracting the aberration-changing lens unit La into and from the optical path enables picking up images with different video image representations.

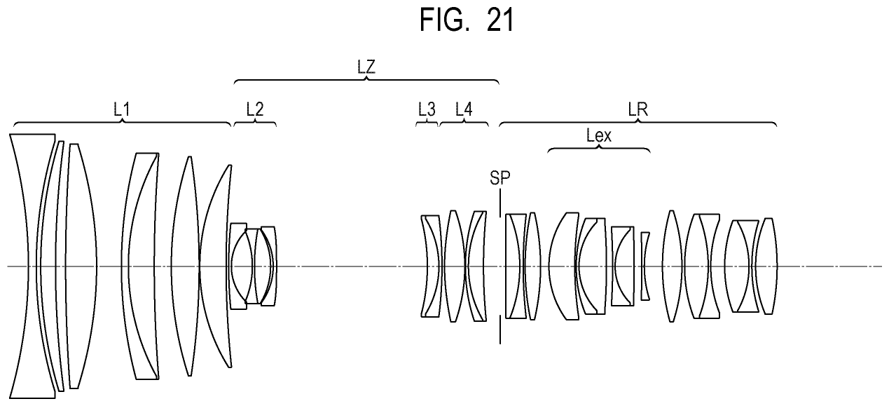

FIG. 21 is a cross-sectional view of the zoom lens according to Embodiment 8 in a state in which the extender lens unit Lex that changes the focal length to the long focal length side is disposed at the insertion/removal position in the optical path, at the wide angle end and in an infinity in-focus state. FIG. 21 is a cross-sectional view illustrating a state in which the extender lens unit Lex of Embodiment 8 is disposed at the insertion/removal position in the retracted state illustrated in FIG. 17. In the present embodiment, the extender lens unit Lex for changing the focal length of the zoom lens to the long focal length side is exemplified, but the present disclosure is not limited thereto, and any lens unit for changing the focal length may be used.

The extender lens unit Lex in the zoom lens of Embodiment 8 is composed of a meniscus positive lens convex to the object side, a cemented lens composed of a meniscus negative lens convex to the object side and a positive lens, a cemented lens composed of a negative lens and a positive lens, and a negative lens, which are arranged in order from the object side to the image side. The extender lens unit Lex in Embodiment 8 corresponds to the thirty-fifth surface to the forty-fourth surface.

When the extender lens unit Lex is disposed at the insertion/removal position, the focal length of the zoom lens is set to 1.47 times the focal length in the state (retracted state) in which neither the aberration-changing lens unit La nor the extender lens unit Lex is disposed.

The values corresponding to the inequalities (1) to (10) in Embodiment 8 are summarized in Table 1. The zoom lens of Embodiment 8 satisfies all the inequalities (1) to (10), and enables picking up images with the same imaging magnification and different video image representations while being small in size.

In the zoom lenses of Embodiments 1 to 8, the rear lens unit LR does not move for zooming, but a part (partial lens unit) of the rear lens unit LR may move for zooming, and even in such case, the above-described effects can be obtained. For example, in the zoom lens of Embodiment 1 shown in FIG. 3, a portion from the thirty-eighth surface to the forty-seventh surface in the rear lens unit LR may move in the optical axis direction. Since a substantially afocal light beam is incident on the thirty-eighth surface from the object side, even if the portion moves, the optical characteristics other than the back focus are substantially unchanged. By moving the portion, it is possible to correct a change in focus caused by a change in the state of the zoom lens such as zooming, focusing, operation of the aperture stop, temperature, atmospheric pressure, posture, and insertion/removal of the variable magnification optical system.

### NUMERICAL EMBODIMENTS

Numerical Embodiments 1 to 8 corresponding to Embodiments 1 to 8 of the present disclosure will be described below.

In each numerical embodiment, ri is the radius of curvature (mm) of the i-th surface from the object side, di is the distance (lens thickness or air distance) (mm) between the i-th surface and the (i+1)-th surface, and ndi and vdi are the refractive index and Abbe number with respect to the d-line of the optical medium (lens glass material or air) between the i-th surface and the (i+1)-th surface, respectively. The Abbe number vd is expressed as follows,

vd=(nd−1)/(nF−nC)

where nF, nd, and nC represent the refractive indices of the Fraunhofer line with respect to the F line, the d line, and the C line, respectively.

The half angle of view ω (degrees) is defined as follows,

ω=arctan(Y/fw)

where 2Y is the diagonal size of the image pickup element of the image pickup apparatus in which the zoom lens is used, and fw represents the focal length of the zoom lens at the wide angle end. The maximum image height (mm) corresponds to half Y (e.g., 5.50 mm) of the diagonal size 2Y (e.g., 11.00 mm).

BF is a back focus (mm), and is the distance on the optical axis from the final surface (the lens surface closest to the image side) of the zoom lens to the paraxial image plane represented by an air conversion length. The total lens length (mm) is a length obtained by adding the back focus to the distance on the optical axis from the forefront surface (lens surface closest to the object side) of the zoom lens to the final surface.

The “*” attached to the right of the surface number means that the surface has an aspherical shape.

The aspherical surface shape is expressed by the following formula,

$$X = \frac{\frac{{H}^{2}}{R}}{1 + \sqrt{1 - ( 1 + k ) {( \frac{H}{R} )}^{2}}} + A 4 {H}^{4} + A 6 {H}^{6} + A 8 {H}^{8} + A 10 {H}^{12} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

where X represents an amount of displacement from the surface vertex in the optical axis direction, His a height from the optical axis in the direction orthogonal to the optical axis, the traveling direction of light is positive, R is a paraxial radius of curvature, k is a conic constant, and A3 to A16 are aspherical surface coefficients. Coefficients not listed in the numerical embodiments are zero. For example, “e-Z” means “×10^{-Z}”.

### NUMERICAL EMBODIMENTS

[State (Retracted State) in Embodiments 1 to 7 where the Aberration-Changing Lens Unit La is not in the Optical Path]

Unit mm
Surface Data

| Surface number | r | d | nd | νd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29 (stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 35.00 | | |
| 33 | 45.791 | 4.93 | 1.75520 | 27.5 |
| 34 | −176.937 | 2.78 | | |
| 35 | 367.396 | 0.90 | 2.00100 | 29.1 |
| 36 | 22.124 | 6.97 | 1.49700 | 81.5 |
| 37 | −88.326 | 0.20 | | |
| 38 | 357.352 | 4.77 | 1.48749 | 70.2 |
| 39 | −28.360 | 0.90 | 1.88300 | 40.8 |
| 40 | −204.507 | 0.15 | | |
| 41 | 43.617 | 6.23 | 1.48749 | 70.2 |
| 42 | −42.787 | 4.00 | | |
| 43 | ∞ | 33.00 | 1.60859 | 46.4 |
| 44 | ∞ | 13.20 | 1.51633 | 64.1 |
| 45 | ∞ | 6.99 | | |

| | |
|---|---|
| Image plane | ∞ |

Aspherical Data
Thirteenth surface
K = 1.99983e 00 A 4 = 1.77649e−05 A 6 = −5.29341e−08 A 8 = 3.29999e−10
A10 = 1.02584e−11 A12 = −2.22171e−13 A14 = 1.50679e−15 A16 = −3.44562e−18
Twenty-fifth surface
K = −1.91921e−01 A 4 = 8.11367e−07 A 6 = 7.19921e−09 A 8 = −1.46342e−10
A10 = 1.41032e−12 A12 = −6.88616e−15 A14 = 1.65877e−17 A16 = −1.56715e−20

Various Data
Zoom Ratio 25.91

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 52.73 |

### Numerical Embodiment 1

Unit mm
Surface Data

| Surface number | r | D | nd | νd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 12.32 | | |
| 33 | 55.477 | 3.93 | 1.60342 | 38.0 |
| 34 | −477.535 | 1.50 | 1.89190 | 37.1 |
| 35 | 73.472 | 5.20 | | |
| 36 | −70.982 | 3.61 | 1.88300 | 40.8 |
| 37 | −65.183 | 8.44 | | |
| 38 | 45.791 | 4.93 | 1.75520 | 27.5 |
| 39 | −176.937 | 2.78 | | |
| 40 | 367.396 | 0.90 | 2.00100 | 29.1 |
| 41 | 22.124 | 6.97 | 1.49700 | 81.5 |
| 42 | −88.326 | 0.20 | | |
| 43 | 357.352 | 4.77 | 1.48749 | 70.2 |
| 44 | −28.360 | 0.90 | 1.88300 | 40.8 |
| 45 | −204.507 | 0.15 | | |
| 46 | 43.617 | 6.23 | 1.48749 | 70.2 |
| 47 | −42.787 | 4.00 | | |
| 48 | ∞ | 33.00 | 1.60859 | 46.4 |
| 49 | ∞ | 13.20 | 1.51633 | 64.1 |
| 50 | ∞ | 6.99 | | |

| | |
|---|---|
| Image plane | ∞ |

Aspherical Data
Thirteenth surface
K = 1.99983e 00 A 4 = 1.77649e−05 A 6 = −5.29341e−08 A 8 = 3.29999e−10
A10 = 1.02584e−11 A12 = −2.22171e−13 A14 = 1.50679e−15 A16 = −3.44562e−18
Twenty-fifth surface
K = −1.91921e−01 A 4 = 8.11367e−07 A 6 = 7.19921e−09 A 8 = −1.46342e−10
A10 = 1.41032e−12 A12 = −6.88616e−15 A14 = 1.65877e−17 A16 = −1.56715e−20

Various Data
Zoom Ratio 25.91

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 54.20 |

### Numerical Embodiment 2

Unit mm
Surface Data

| Surface number | r | d | nd | νd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 9.78 | | |
| 33 | 111.496 | 5.60 | 2.00100 | 29.1 |
| 34 | 104.081 | 9.27 | | |
| 35 | −37.544 | 2.45 | 1.43875 | 94.7 |
| 36 | −37.031 | 7.90 | | |
| 37 | 45.791 | 4.93 | 1.75520 | 27.5 |
| 38 | −176.937 | 2.78 | | |
| 39 | 367.396 | 0.90 | 2.00100 | 29.1 |
| 40 | 22.124 | 6.97 | 1.49700 | 81.5 |
| 41 | −88.326 | 0.20 | | |
| 42 | 357.352 | 4.77 | 1.48749 | 70.2 |
| 43 | −28.360 | 0.90 | 1.88300 | 40.8 |
| 44 | −204.507 | 0.15 | | |
| 45 | 43.617 | 6.23 | 1.48749 | 70.2 |
| 46 | −42.787 | 4.00 | | |
| 47 | ∞ | 33.00 | 1.60859 | 46.4 |
| 48 | ∞ | 13.20 | 1.51633 | 64.1 |
| 49 | ∞ | 6.99 | | |
| Image plane | ∞ | | | |

Aspherical Data
Thirteenth surface
K = 1.99983e 00 A 4 = 1.77649e−05 A 6 = −5.29341e−08 A 8 = 3.29999e−10
A10 = 1.02584e−11 A12 = −2.22171e−13 A14 = 1.50679e−15 A16 = −3.44562e−18
Twenty-fifth surface
K = −1.91921e−01 A 4−8.11367e−07 A 6−7.19921e−09 A 8 = −1.46342e−10
A10 = 1.41032e−12 A12 = −6.88616e−15 A14 = 1.65877e−17 A16 = −1.56715e−20

Various Data
Zoom Ratio 25.91

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 54.03 |

### Numerical Embodiment 3

Unit mm
Surface Data

| Surface number | r | d | nd | vd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 7.62 | | |
| 33 | 66.481 | 4.37 | 1.62004 | 36.3 |
| 34 | −434.248 | 1.50 | 1.80440 | 39.6 |
| 35 | 107.126 | 6.49 | | |
| 36 | −65.189 | 1.50 | 1.63854 | 55.4 |
| 37 | 64.241 | 5.47 | 1.51633 | 64.1 |
| 38 | −53.943 | 8.05 | | |
| 39 | 45.791 | 4.93 | 1.75520 | 27.5 |
| 40 | −176.937 | 2.78 | | |
| 41 | 367.396 | 0.90 | 2.00100 | 29.1 |
| 42 | 22.124 | 6.97 | 1.49700 | 81.5 |
| 43 | −88.326 | 0.20 | | |
| 44 | 357.352 | 4.77 | 1.48749 | 70.2 |
| 45 | −28.360 | 0.90 | 1.88300 | 40.8 |
| 46 | −204.507 | 0.15 | | |
| 47 | 43.617 | 5.23 | 1.48749 | 70.2 |
| 48 | −42.787 | 4.00 | | |
| 49 | ∞ | 33.00 | 1.60859 | 46.4 |
| 50 | ∞ | 13.20 | 1.51633 | 64.1 |
| 51 | ∞ | 6.99 | | |
| Image plane | ∞ | | | |

Aspherical Data
Thirteenth surface
K = 1.99983e 00 A 4 = 1.77649e−05 A 6 = −5.29341e−08
A 8 = 3.29999e−10 A10 = 1.02584e−11 A12 = −2.22171e−13
A14 = 1.50679e−15 A16 = −3.44562e−18
Twenty-fifth surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data

| | |
|---|---|
| Zoom Ratio | 25.91 |

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 54.46 |

### Numerical Embodiment 4

Unit mm
Surface Data

| Surface number | r | d | nd | vd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 7.76 | | |
| 33 | 132.608 | 5.00 | 1.62004 | 36.3 |
| 34 | −59.393 | 1.50 | 1.80440 | 39.6 |
| 35 | 1453.992 | 4.31 | | |
| 36 | −38.750 | 1.50 | 1.63854 | 55.4 |
| 37 | 1033.812 | 5.68 | 1.51633 | 64.1 |
| 38 | −35.604 | 9.24 | | |
| 39 | 45.791 | 4.93 | 1.75520 | 27.5 |
| 40 | −176.937 | 2.78 | | |
| 41 | 367.396 | 0.90 | 2.00100 | 29.1 |
| 42 | 22.124 | 6.97 | 1.49700 | 81.5 |
| 43 | −88.326 | 0.20 | | |
| 44 | 357.352 | 4.77 | 1.48749 | 70.2 |
| 45 | −28.360 | 0.90 | 1.88300 | 40.8 |
| 46 | −204.507 | 0.15 | | |
| 47 | 43.617 | 6.23 | 1.48749 | 70.2 |
| 48 | −42.787 | 4.00 | | |
| 49 | ∞ | 33.00 | 1.60859 | 46.4 |
| 50 | ∞ | 13.20 | 1.51633 | 64.1 |
| 51 | ∞ | 6.99 | | |
| Image plane | ∞ | | | |

Aspherical Data
Thirteenth surface
K = 1.99983e 00 A 4 = 1.77649e−05 A 6 = −5.29341e−08
A 8 = 3.29999e−10 A10 = 1.02584e−11 A12 = −2.22171e−13
A14 = 1 .50679e−15 A16 = −3.44562e−18
Twenty-fifth surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data

| | |
|---|---|
| Zoom Ratio | 25.91 |

| | Wide angle | Intermediate | Telephoto |
|---|---|---|---|
| Focal length | 7.20 | 36.64 | 186.53 |
| F number | 1.80 | 1.80 | 2.81 |
| Half angle of view | 37.38 | 8.54 | 1.69 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 50.93 |

### Numerical Embodiment 5

Unit mm
Surface Data

| Surface number | r | d | nd | vd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 6.52 | | |
| 33 | 35.610 | 5.08 | 1.62004 | 36.3 |
| 34 | 706.596 | 1.50 | 1.80440 | 39.6 |
| 35 | 40.571 | 4.56 | | |
| 36 | −578.515 | 1.50 | 1.64850 | 53.0 |
| 37 | 58.164 | 5.24 | 1.49700 | 81.5 |
| 38 | −111.576 | 10.59 | | |
| 39 | 45.791 | 4.93 | 1.75520 | 27.5 |
| 40 | −176.937 | 2.78 | | |
| 41 | 367.396 | 0.90 | 2.00100 | 29.1 |
| 42 | 22.124 | 6.97 | 1.49700 | 81.5 |
| 43 | −88.326 | 0.20 | | |
| 44 | 357.352 | 4.77 | 1.48749 | 70.2 |
| 45 | −28.360 | 0.90 | 1.88300 | 40.8 |
| 46 | −204.507 | 0.15 | | |
| 47 | 43.617 | 6.23 | 1.48749 | 70.2 |
| 48 | −42.787 | 4.00 | | |
| 49 | ∞ | 33.00 | 1.60859 | 46.4 |
| 50 | ∞ | 13.20 | 1.51633 | 64.1 |
| 51 | ∞ | 6.99 | | |
| Image plane | ∞ | | | |

Aspherical Data
Thirteenth surface
K = 1.99983e 00 A 4 = 1.77649e−05 A 6 = −5.29341e−08
A 8 = 3.29999e−10 A10 = 1.02584e−11 A12 = −2.22171e−13
A14 = 1.50679e−15 A16 = −3.44562e−18
Twenty-fifth surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data

| | |
|---|---|
| Zoom Ratio | 25.91 |

| | Wide angle | Intermediate | Telephoto |
|---|---|---|---|
| Focal length | 7.96 | 40.50 | 206.17 |
| F number | 1.89 | 1.89 | 3.10 |
| Half angle of view: | 34.66 | 7.73 | 1.53 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 58.36 |

### Numerical Embodiment 6

Unit mm
Surface Data

| Surface number | r | d | nd | vd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 7.53 | | |
| 33 | −128.617 | 1.32 | 1.69680 | 55.5 |
| 34 | 98.798 | 4.37 | 1.51742 | 52.4 |
| 35 | −81.206 | 5.29 | | |
| 36 | 49.910 | 4.10 | 1.43875 | 94.7 |
| 37 | 643.919 | 1.22 | 1.49700 | 81.5 |
| 38 | 58.875 | 11.17 | | |
| 39 | 45.791 | 4.93 | 1.75520 | 27.5 |
| 40 | −176.937 | 2.78 | | |
| 41 | 367.396 | 0.90 | 2.00100 | 29.1 |
| 42 | 22.124 | 6.97 | 1.49700 | 81.5 |
| 43 | −88.326 | 0.20 | | |
| 44 | 357.352 | 4.77 | 1.48749 | 70.2 |
| 45 | −28.360 | 0.90 | 1.88300 | 40.8 |
| 46 | −204.507 | 0.15 | | |
| 47 | 43.617 | 6.23 | 1.48749 | 70.2 |
| 48 | −42.787 | 4.00 | | |
| 49 | ∞ | 33.00 | 1.60859 | 46.4 |
| 50 | ∞ | 13.20 | 1.51633 | 64.1 |
| 51 | ∞ | 6.99 | | |
| Image plane | ∞ | | | |

Aspherical Data
Thirteenth surface
K = 1.99983e 00 A 4 = 1.77649e−05 A 6 = −5.29341e−08
A 8 = 3.29999e−10 A10 = 1.02584e−11 A12 = −2.22171e−13
A14 = 1.50679e−15 A16 = −3.44562e−18
Twenty-fifth surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data

| | |
|---|---|
| Zoom Ratio | 25.91 |

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 54.55 |

### Numerical Embodiment 7

Unit mm
Surface Data

| Surface number | r | d | nd | vd |
|---|---|---|---|---|
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (variable) | | |
| 21 | −36.661 | 0.90 | 1.95375 | 32.3 |
| 22 | 125.708 | 3.28 | 1.92286 | 18.9 |
| 23 | −79.329 | (variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (variable) | | |
| 29(stop) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 7.55 | | |
| 33 | −1000.985 | 1.72 | 1.88300 | 40.8 |
| 34 | 42.883 | 5.02 | 1.59551 | 39.2 |
| 35 | −189.688 | 1.45 | | |
| 36 | −88.886 | 2.28 | 2.00100 | 29.1 |
| 37 | −71.479 | 0.47 | | |
| 38 | 32.218 | 4.28 | 1.43875 | 94.7 |
| 39 | 84.897 | 1.48 | 1.64000 | 60.1 |
| 40 | 41.435 | 10.74 | | |
| 41 | 45.791 | 4.93 | 1.75520 | 27.5 |
| 42 | −176.937 | 2.78 | | |
| 43 | 367.396 | 0.90 | 2.00100 | 29.1 |
| 44 | 22.124 | 6.97 | 1.49700 | 81.5 |
| 45 | −88.326 | 0.20 | | |
| 46 | 357.352 | 4.77 | 1.48749 | 70.2 |
| 47 | −28.360 | 0.90 | 1.88300 | 40.8 |
| 48 | −204.507 | 0.15 | | |
| 49 | 43.617 | 6.23 | 1.48749 | 70.2 |
| 50 | −42.787 | 4.00 | | |
| 51 | ∞ | 33.00 | 1.60859 | 46.4 |
| 52 | ∞ | 13.20 | 1.51633 | 64.1 |
| 53 | ∞ | 6.99 | | |
| Image plane | ∞ | | | |

Aspherical Data
Thirteenth surface
K = 1.99983e 00 A 4 = 1.77649e−05 A 6 = −5.29341e−08
A 8 = 3.29999e−10 A10 = 1.02584e−11 A12 = −2.22171e−13
A14 = 1.50679e−15 A16 = −3.44562e−18
Twenty-fifth surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data

| | |
|---|---|
| Zoom Ratio | 25.91 |

| | Wide angle | Intermediate | Telephoto |
|---|---|---|---|
| Focal length | 7.58 | 38.57 | 196.35 |
| F number | 1.80 | 1.80 | 2.95 |
| Half angle of view | 35.97 | 8.12 | 1.60 |
| Image height | 5.50 | 5.50 | 5.50 |
| Lens Length | 293.25 | 293.25 | 293.25 |
| BF | 40.21 | 40.21 | 40.21 |
| d12 | 0.70 | 42.85 | 58.25 |
| d20 | 68.05 | 8.39 | 3.40 |
| d23 | 1.81 | 15.76 | 1.10 |
| d28 | 3.17 | 6.73 | 10.98 |

Lens unit Data

| Unit | Leading surface | Focal length |
|---|---|---|
| 1 | 1 | 72.15 |
| 2 | 13 | −12.90 |
| 3 | 21 | −71.58 |
| 4 | 24 | 36.72 |
| 5 | 29 | 55.48 |

[A State where the Aberration-Changing Lens Unit La and the Extender Lens Unit Lex of Embodiment 8 are not in the Optical Path (Retracted State)]

Unit mm
Surface Data

| Surface number | r | d | nd | vd |
|---|---|---|---|---|
| 1 | −167.132 | 2.80 | 1.74951 | 35.3 |
| 2 | 151.086 | 1.60 | | |
| 3 | 154.019 | 5.33 | 1.95906 | 17.5 |
| 4 | 330.708 | 3.62 | | |
| 5 | 594.579 | 11.14 | 1.60311 | 60.6 |
| 6* | −138.092 | 8.88 | | |
| 7 | 154.488 | 2.50 | 1.84666 | 23.8 |
| 8 | 80.966 | 9.30 | 1.43875 | 94.7 |
| 9 | 496.359 | 6.12 | | |
| 10 | 126.600 | 10.01 | 1.43387 | 95.1 |
| 11 | −265.687 | 0.20 | | |
| 12 | 67.442 | 9.49 | 1.59522 | 67.7 |
| 13 | 335.462 | (variable) | | |
| 14 | 155.823 | 0.95 | 1.75500 | 52.3 |
| 15 | 17.668 | 7.56 | | |
| 16 | −31.693 | 0.75 | 1.49700 | 81.5 |
| 17 | 73.352 | 5.80 | 1.80000 | 29.8 |
| 18 | −25.439 | 0.94 | | |
| 19 | −21.645 | 1.20 | 1.76385 | 48.5 |
| 20* | −261.202 | (variable) | | |
| 21 | −67.686 | 4.15 | 1.80810 | 22.8 |
| 22 | −32.336 | 1.10 | 1.90525 | 35.0 |
| 23 | −141.104 | (variable) | | |
| 24 | 76.972 | 7.29 | 1.64000 | 60.1 |
| 25 | −59.614 | 0.19 | | |
| 26 | 60.585 | 1.10 | 1.85478 | 24.8 |
| 27 | 37.997 | 5.41 | 1.48749 | 70.2 |
| 28 | 190.983 | (variable) | | |
| 29(stop) | ∞ | 2.07 | | |
| 30 | −27250.420 | 4.98 | 1.48749 | 70. |
| 31 | −49.195 | 1.20 | 2.00100 | 29.1 |
| 32 | 156.424 | 0.69 | | |
| 33 | 93.126 | 5.55 | 1.72825 | 28.5 |
| 34 | −84.236 | 43.77 | | |
| 35 | 73.828 | 7.00 | 1.43875 | 94.7 |
| 36 | −63.688 | 0.95 | | |
| 37 | 52.065 | 8.49 | 1.80810 | 22.8 |
| 38 | −51.533 | 0.90 | 1.95375 | 32.3 |
| 39 | 45.461 | 5.00 | | |
| 40 | 46.480 | 8.76 | 1.48749 | 70.2 |
| 41 | −32.543 | 1.00 | 2.00100 | 29.1 |
| 42 | 53.732 | 1.36 | | |
| 43 | 43.575 | 7.72 | 1.62004 | 36.3 |
| 44 | −81.025 | 43.42 | | |
| Image plane | ∞ | | | |

Aspherical Data
Sixth surface
K = −1.51267e 01 A 4 = −6.49448e−07 A 6 = 2.35413e−10
A 8 = −9.02147e−14 A10 = 2.62134e−17 A12 = −3.74536e−21
Twentieth surface
K = 3.72020e 01 A 4 = −9.83020e−06 A 6 = −4.95860e−09
A 8 = −2.35672e−11 A10 = 5.83243e−14 A12 = −2.06036e−16
Twenty-fourth surface
K = −1.45023e 00 A 4 = −1.99598e−06 A 6 = 6.26743e−10
A 8 = 8.22589e−13 A10 = −4.34519e−15 A12 = 5.01150e−18

Various Data

| | |
|---|---|
| Zoom Ratio | 9.53 |

| | Wide angle | Intermediate | Telephoto |
|---|---|---|---|
| Focal length | 25.99 | 77.32 | 247.69 |
| F number | 2.73 | 2.73 | 3.64 |
| Half field angle | 29.65 | 10.84 | 3.42 |
| Image height | 14.80 | 14.80 | 14.80 |
| Lens total length | 312.24 | 312.24 | 312.24 |
| BF | 43.42 | 43.42 | 43.42 |
| d13 | 0.92 | 33.97 | 51.76 |
| d20 | 54.15 | 4.53 | 2.01 |
| d23 | 0.91 | 18.14 | 1.22 |
| d28 | 5.99 | 5.33 | 6.98 |

Lens unit Data

| Unit | Leading surface | Focal length |
|---|---|---|
| 1 | 1 | 80.71 |
| 2 | 14 | −18.55 |
| 3 | 21 | −119.35 |
| 4 | 24 | 47.81 |
| 5 | 29 | 122.321 |

### Numerical Embodiment 8

(FIG. 11 illustrates a state in which an aberration-changing lens unit La according to an eighth exemplary embodiment is disposed at an insertion/removal position of an optical path.)

Unit mm
Surface Data

| Surface number | r | d | nd | vd |
|---|---|---|---|---|
| 1 | −167.132 | 2.80 | 1.74951 | 35.3 |
| 2 | 151.086 | 1.60 | | |
| 3 | 154.019 | 5.33 | 1.95906 | 17.5 |
| 4 | 330.708 | 3.62 | | |
| 5 | 594.579 | 11.14 | 1.60311 | 60.6 |
| 6* | −138.092 | 8.88 | | |
| 7 | 154.488 | 2.50 | 1.84666 | 23.8 |
| 8 | 80.966 | 9.30 | 1.43875 | 94.7 |
| 9 | 496.359 | 6.12 | | |
| 10 | 126.600 | 10.01 | 1.43387 | 95.1 |
| 11 | −265.687 | 0.20 | | |
| 12 | 67.442 | 9.49 | 1.59522 | 67.7 |
| 13 | 335.462 | (variable) | | |
| 14 | 155.823 | 0.95 | 1.75500 | 52.3 |
| 15 | 17.668 | 7.56 | | |
| 16 | −31.693 | 0.75 | 1.49700 | 81.5 |
| 17 | 73.352 | 5.80 | 1.80000 | 29.8 |
| 18 | −25.439 | 0.94 | | |
| 19 | −21.645 | 1.20 | 1.76385 | 48.5 |
| 20* | −261.202 | (variable) | | |
| 21 | −67.686 | 4.15 | 1.80810 | 22.8 |
| 22 | −32.336 | 1.10 | 1.90525 | 35.0 |
| 23 | −141.104 | (variable) | | |
| 24* | 76.972 | 7.29 | 1.64000 | 60.1 |
| 25 | −59.614 | 0.19 | | |
| 26 | 60.585 | 1.10 | 1.85478 | 24.8 |
| 27 | 37.997 | 5.41 | 1.48749 | 70.2 |
| 28 | 190.983 | (variable) | | |
| 29(stop) | ∞ | 2.07 | | |
| 30 | −27250.420 | 4.98 | 1.48749 | 70.2 |
| 31 | −49.195 | 1.20 | 2.00100 | 29.1 |
| 32 | 156.424 | 0.69 | | |
| 33 | 93.126 | 5.55 | 1.72825 | 28.5 |
| 34 | −84.236 | 9.40 | | |
| 35 | 68.620 | 7.62 | 1.48749 | 70.2 |
| 36 | 65.054 | 7.85 | | |
| 37 | −178.110 | 1.50 | 1.76385 | 48.5 |
| 38 | 143.845 | 4.47 | 1.53172 | 48.8 |
| 39 | −91.015 | 12.93 | | |
| 40 | 73.828 | 7.00 | 1.43875 | 94.7 |
| 41 | −63.688 | 0.95 | | |
| 42 | 52.065 | 8.49 | 1.80810 | 22.8 |
| 43 | −51.533 | 0.90 | 1.95375 | 32.3 |
| 44 | 45.461 | 5.00 | | |
| 45 | 46.480 | 8.76 | 1.48749 | 70.2 |
| 46 | −32.543 | 1.00 | 2.00100 | 29.1 |
| 47 | 53.732 | 1.36 | | |
| 48 | 43.575 | 7.72 | 1.62004 | 36.3 |
| 49 | −81.025 | 43.42 | | |
| Image plane | ∞ | | | |

Aspherical Data
Sixth surface
K = −1.51267e 01 A 4 = −6.49448e−07 A 6 = 2.35413e−10
A 8 = −9.02147e−14 A10 = 2.62134e−17 A12 = −3.74536e−21
Twentieth surface
K = 3.72020e 01 A 4 = −9.83020e−06 A 6 = −4.95860e−09
A 8 = −2.35672e−11 A10 = 5.83243e−14 A12 = −2.06036e−16
Twenty-fourth surface
K = −1.45023e 00 A 4 = −1.99598e−06 A 6 = 6.26743e−10
A 8 = 8.22589e−13 A10 = −4.34519e−15 A12 = 5.01150e−18

Various Data

| | |
|---|---|
| Zoom Ratio | 9.53 |

| | Wide angle | Intermediate | Telephoto |
|---|---|---|---|
| Focal length | 25.99 | 77.32 | 247.69 |
| F number | 2.73 | 2.73 | 3.64 |
| Half field angle | 29.65 | 10.84 | 3.42 |
| Image height | 14.80 | 14.80 | 14.80 |
| Lens total length | 312.24 | 312.24 | 312.24 |
| BF | 43.42 | 43.42 | 43.42 |
| d13 | 0.92 | 33.97 | 51.76 |
| d20 | 54.15 | 4.53 | 2.01 |
| d23 | 0.91 | 18.14 | 1.22 |
| d28 | 5.99 | 5.33 | 6.98 |

Lens unit Data

| Unit | Leading surface | Focal length |
|---|---|---|
| 1 | 1 | 80.71 |
| 2 | 14 | −18.55 |
| 3 | 21 | −119.35 |
| 4 | 24 | 47.81 |
| 5 | 29 | 125.05 |

### Numerical Embodiment 8 IE

(FIG. 19 illustrates a state in which an extender lens unit Lex according to an eighth exemplary embodiment is disposed at an insertion/removal position of an optical path.)

Unit mm
Surface Data

| Surface number | r | d | nd | vd |
|---|---|---|---|---|
| 1 | −167.132 | 2.80 | 1.74951 | 35.3 |
| 2 | 151.086 | 1.60 | | |
| 3 | 154.019 | 5.33 | 1.95906 | 17.5 |
| 4 | 330.708 | 3.62 | | |
| 5 | 594.579 | 11.14 | 1.60311 | 60.6 |
| 6* | −138.092 | 8.88 | | |
| 7 | 154.488 | 2.50 | 1.84666 | 23.8 |
| 8 | 80.966 | 9.30 | 1.43875 | 94.7 |
| 9 | 496.359 | 6.12 | | |
| 10 | 126.600 | 10.01 | 1.43387 | 95.1 |
| 11 | −265.687 | 0.20 | | |
| 12 | 67.442 | 9.49 | 1.59522 | 67.7 |
| 13 | 335.462 | (variable) | | |
| 14 | 155.823 | 0.95 | 1.75500 | 52.3 |
| 15 | 17.668 | 7.56 | | |
| 16 | −31.693 | 0.75 | 1.49700 | 81.5 |
| 17 | 73.352 | 5.80 | 1.80000 | 29.8 |
| 18 | −25.439 | 0.94 | | |
| 19 | −21.645 | 1.20 | 1.76385 | 48.5 |
| 20* | −261.202 | (variable) | | |
| 21 | −67.686 | 4.15 | 1.80810 | 22.8 |
| 22 | −32.336 | 1.10 | 1.90525 | 35.0 |
| 23 | −141.104 | (variable) | | |
| 24* | 76.972 | 7.29 | 1.64000 | 60.1 |
| 25 | −59.614 | 0.19 | | |
| 26 | 60.585 | 1.10 | 1.85478 | 24.8 |
| 27 | 37.997 | 5.41 | 1.48749 | 70.2 |
| 28 | 190.983 | (variable) | | |
| 29(stop) | ∞ | 2.07 | | |
| 30 | −27250.420 | 4.98 | 1.48749 | 70.2 |
| 31 | −49.195 | 1.20 | 2.00100 | 29.1 |
| 32 | 156.424 | 0.69 | | |
| 33 | 93.126 | 5.55 | 1.72825 | 28.5 |
| 34 | −84.236 | 3.00 | | |
| 35 | 31.944 | 9.29 | 1.49700 | 81.5 |
| 36 | 117.598 | 0.50 | | |
| 37 | 44.893 | 1.00 | 2.00100 | 29.1 |
| 38 | 22.620 | 9.88 | 1.56732 | 42.8 |
| 39 | −210.180 | 2.21 | | |
| 40 | −226.397 | 0.88 | 1.88300 | 40.8 |
| 41 | 18.353 | 6.79 | 1.72825 | 28.5 |
| 42 | −701.782 | 2.81 | | |
| 43 | −342.999 | 0.90 | 1.59522 | 67.7 |
| 44 | 38.480 | 6.51 | | |
| 45 | 73.828 | 7.00 | 1.43875 | 94.7 |
| 46 | −63.688 | 0.95 | | |
| 47 | 52.065 | 8.49 | 1.80810 | 22.8 |
| 48 | −51.533 | 0.90 | 1.95375 | 32.3 |
| 49 | 45.461 | 5.00 | | |
| 50 | 46.480 | 8.76 | 1.48749 | 70.2 |
| 51 | −32.543 | 1.00 | 2.00100 | 29.1 |
| 52 | 53.732 | 1.36 | | |
| 53 | 43.575 | 7.72 | 1.62004 | 36.3 |
| 54 | −81.025 | 43.42 | | |
| Image plane | ∞ | | | |

Aspherical Data
Sixth surface
K = −1.51267e 01 A 4 = −6.49448e−07 A 6 = 2.35413e−10
A 8 = −9.02147e−14 A10 = 2.62134e−17 A12 = −3.74536e−21
Twentieth surface
K = 3.72020e 01 A 4 = −9.83020e−06 A 6 = −4.95860e−09
A 8 = −2.35672e−11 A10 = 5.83243e−14 A12 = −2.06036e−16
Twenty-fourth surface
K = −1.45023e 00 A 4 = −1.99598e−06 A 6 = 6.26743e−10
A 8 = 8.22589e−13 A10 = −4.34519e−15 A12 = 5.01150e−18

Various Data

| | |
|---|---|
| Zoom Ratio | 9.53 |

| | Wide angle | Intermediate | Telephoto |
|---|---|---|---|
| Focal length | 38.21 | 113.66 | 364.10 |
| F number | 4.02 | 4.02 | 5.35 |
| Half angle of view | 21.17 | 7.42 | 2.33 |
| Image height | 14.80 | 14.80 | 14.80 |
| Lens total length | 312.24 | 312.24 | 312.24 |
| BF | 43.42 | 43.42 | 43.42 |
| d13 | 0.92 | 33.97 | 51.76 |
| d20 | 54.15 | 4.53 | 2.01 |
| d23 | 0.91 | 18.14 | 1.22 |
| d28 | 5.99 | 5.33 | 6.98 |

Lens unit Data

| Unit | Leading surface | Focal length |
|---|---|---|
| 1 | 1 | 80.71 |
| 2 | 14 | −18.55 |
| 3 | 21 | −119.35 |
| 4 | 24 | 47.81 |
| 5 | 29 | 492.28 |

TABLE 1
Values of each numerical embodiment for the inequalities (1)-(10)

| | | Numerical Embodiment | | | | | | | |
|---|---|---|---|---|---|---|---|---|---|
| Inequality | | 1 | 2 | 3 | 4 | 5 | 6 | 7 | 8 |
| (1) | fwa/fw | 1.000 | 1.000 | 1.000 | 0.950 | 1.050 | 1.000 | 1.000 | 1.000 |
| (2) | skwa/skw | 1.000 | 1.000 | 1.000 | 1.000 | 1.000 | 1.000 | 1.000 | 1.000 |
| (3) | \|fa/fw\| | 201778 | 235341 | 174379 | 2997 | 3038 | 164097 | 111392 | 635 |
| (4) | \|SAw/SAwa\| | 0.111 | 0.113 | 0.120 | 0.105 | 0.109 | 0.116 | 0.055 | 0.002 |
| (5) | Raf/Ral | −0.851 | −3.011 | −1.232 | −3.725 | −0.319 | −2.185 | −24.158 | −0.754 |
| (6) | \|fw/fai\| | 0.011 | 0.003 | 0.013 | 0.008 | 0.006 | 0.005 | 0.033 | 0.003 |
| (7) | Ndan − Ndap | 0.149 | 0.562 | 0.153 | 0.153 | 0.167 | 0.119 | 0.205 | 0.094 |
| (8) | βr | 0.022 | 0.022 | 0.022 | 0.022 | 0.022 | 0.022 | 0.022 | 0.343 |
| (9) | \|SAw/fw\| | 0.003 | 0.003 | 0.003 | 0.003 | 0.003 | 0.003 | 0.003 | 0.000 |
| (10) | \|SAwa/fwa\| | 0.030 | 0.029 | 0.028 | 0.033 | 0.029 | 0.028 | 0.060 | 0.025 |
| | fwa | 7.577 | 7.577 | 7.577 | 7.199 | 7.956 | 7.577 | 7.577 | 25.995 |
| | fw | 7.577 | 7.577 | 7.577 | 7.577 | 7.577 | 7.577 | 7.577 | 25.995 |
| | skwa | 40.206 | 40.206 | 40.206 | 40.206 | 40.206 | 40.206 | 40.206 | 43.415 |
| | skw | 40.206 | 40.206 | 40.206 | 40.206 | 40.206 | 40.206 | 40.206 | 43.415 |
| | fa | −1528871 | −1783178 | −1321268 | 22706 | −23016 | −1243361 | −844014 | −16494 |
| | SAwa | −0.226 | −0.221 | 0.209 | −0.238 | −0.229 | −0.215 | −0.451 | −0.657 |
| | SAw | 0.025 | 0.025 | 0.025 | 0.025 | 0.025 | 0.025 | 0.025 | −0.001 |
| | Raf | 55.477 | 111.496 | 66.481 | 132.608 | 35.610 | −128.617 | −1000.985 | 68.620 |
| | Ral | −65.183 | −37.031 | −53.943 | −35.604 | −111.576 | 58.875 | 41.435 | −91.015 |
| | fai | 700 | −2514 | −605 | 933 | −1259 | 1408 | −229 | −8560 |
| | Ndan | 1.892 | 2.001 | 1.721 | 1.721 | 1.726 | 1.597 | 1.883 | 1.626 |
| | Ndap | 1.743 | 1.439 | 1.568 | 1.568 | 1.559 | 1.478 | 1.678 | 1.532 |
| | βr | 0.022 | 0.022 | 0.022 | 0.022 | 0.022 | 0.022 | 0.022 | 0.343 |

### [Imaging Device]

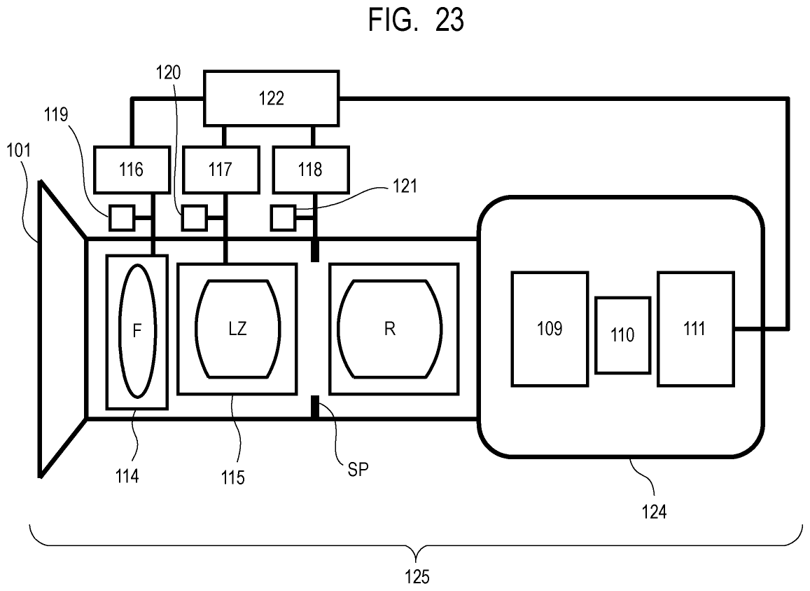

FIG. 23 shows a configuration example of the image pickup device 125. In FIG. 23, reference numeral 101 denotes the zoom lens of any of Embodiments 1 to 8. Reference numeral 124 denotes a camera body. The zoom lens 101 is detachable from the camera body 124. In this drawing, the first lens unit L1 is shown as a lens unit F, the variable-magnification lens unit is shown as a lens unit LZ, and the rear lens unit LR is shown as a lens unit R.

Reference numeral SP denotes an aperture stop, reference numerals 114 and 115 denote drive mechanisms for driving a lens unit for focusing and a lens unit LZ for zooming, respectively, and include a helicoid, a cam, and the like. Reference numerals 116 to 118 denote motors (actuators) for driving the drive mechanisms 114 and 115 and the aperture stop SP. Reference numerals 119 to 121 denote detectors for detecting the position of the lens unit for focusing, the position of the lens unit LZ, and the aperture diameter of the aperture stop SP, and are constituted by an encoder, a potentiometer, a photosensor, and the like.

In the camera main body 124, reference numeral 109 denotes a glass block such as a prism or an optical filter. Reference numeral 110 denotes an image pickup element (photoelectric conversion element) such as a CCD sensor or a CMOS sensor that photoelectrically converts (picks up) an object image formed by the zoom lens 101. Reference numerals 111 and 122 denote processing units that perform various processes and controls in the camera body 124 and the zoom lens 101, respectively, and each include a processor such as a CPU.

By using the zoom lenses of Embodiments 1 to 8 described above, it is possible to provide a small and lightweight image pickup apparatus 125 capable of obtaining a good captured image.

According to the embodiments of the present disclosure, it is possible to provide a zoom lens that is small in size and capable of picking up images having the same imaging magnification and different video image representations.

The embodiments described above are merely representative embodiments, and various modifications and changes can be made to the embodiments in practicing the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074245, filed Apr. 28, 2025, which is hereby incorporated by reference herein in its entirety.

What is claimed is:

1. A zoom lens comprising: in order from an object side to an image side, a first lens unit having a positive refractive power that does not move for zooming, a variable-magnification lens unit including a plurality of lens units that move for zooming, and a rear lens unit that does not move for zooming,
wherein an interval between each lens units adjacent to each other changes during zooming,
wherein the zoom lens comprises an aberration-changing lens unit comprising one or more lenses and configured to change aberration of the zoom lens by being inserted into and removed from an optical path in the rear lens unit; and,
wherein the zoom lens comprises a switching unit for switching between an arrangement state in which the aberration-changing lens unit is arranged in the optical path in the rear lens unit and a retracted state in which the aberration-changing lens unit is retracted from the optical path,
wherein the following inequalities are satisfied,
0.80≤fwa/fw≤1.20
0.95≤skwa/skw≤1.05
where fw represents a focal length of the zoom lens at the wide angle end in the retracted state, fwa represents a focal length of the zoom lens at the wide angle end in the arrangement state, skw represents a back focus at the wide angle end in the retracted state, and skwa represents a back focus at the wide angle end in the arrangement state.

2. The zoom lens according to claim 1, wherein the following inequality is satisfied,
100≤|fa/fw|

where fw represents a focal length at the wide angle end in the retracted state and fa represents a focal length of the aberration-changing lens unit.

3. The zoom lens according to claim 1, wherein the following inequality is satisfied,
0.00≤|SAw/SAwa|≤0.20
where SAw represents an amount of spherical aberration at a 100 percent image-height beam ratio at the wide angle end in the retracted state, and SAwa represents an amount of spherical aberration at the 100 percent image-height beam ratio at the wide angle end in the arrangement state.

4. The zoom lens according to claim 1, wherein the following inequality is satisfied,
−50.00≤Raf/Ra1≤−0.02
where Raf represents a curvature radius of a surface of the aberration-changing lens unit closest to the object side, Ra1 represents a curvature radius of a surface of the aberration-changing lens unit closest to the image side, and a shape convex to the object side is positive and a shape concave to the object side is negative.

5. The zoom lens according to claim 1, wherein the following inequality is satisfied,
0.00≤|fw/fai|≤0.05
where fw represents a focal length at the wide angle end in the retracted state, and fai represents a focal length of a single lens or a cemented lens having a strongest refractive power among single lenses and the cemented lenses included in the aberration-changing lens unit.

6. The zoom lens according to claim 1, wherein the following inequality is satisfied,
0.05≤Ndan−Ndap≤0.60
where Ndap represents an average refractive index of positive lenses included in the aberration-changing lens unit and Ndan represents an average refractive index of negative lenses included in the aberration-changing lens unit.

7. The zoom lens according to claim 1, wherein the following inequality is satisfied,
−0.10≤βr≤0.50
where βr represents a lateral magnification of a lens unit on the image side of the position of the aberration-changing lens unit in the arrangement state, in the retracted state.

8. The zoom lens according to claim 1, wherein the following inequality is satisfied,
0.00≤|SAw/fw|≤0.01
where SAw represents an amount of spherical aberration with respect to d-line at 100 percent image-height beam ratio at the wide angle end in the retracted state, and fw represents a focal length at the wide angle end in the retracted state.

9. The zoom lens according to claim 1, wherein the following inequality is satisfied,
0.01≤|SAwa/fwa|≤0.10
where SAwa represents an amount of spherical aberration with respect to d-line at a 100 percent image-height beam ratio at the wide angle end in the arrangement state, and fwa represents a focal length at the wide angle end in the arrangement state.

10. The zoom lens according to claim 1, further comprising an extender lens unit that is disposed in the optical path in the rear lens unit to change a focal length of the zoom lens toward a long focal length side,
the switching unit switches between a state in which the aberration-changing lens unit is in the optical path, a state in which the extender lens unit is in the optical path, and a state in which the aberration-changing lens unit and the extender lens unit are not in the optical path.

11. An image pickup apparatus, comprising a zoom lens, and, an image pickup element configured to receive an image formed by the zoom lens,
wherein the zoom lens comprises: in order from an object side to an image side, a first lens unit having a positive refractive power that does not move for zooming; a variable-magnification lens unit including a plurality of lens units that move for zooming; and a rear lens unit that does not move for zooming,
wherein an interval between each lens units adjacent to each other changes during zooming,
wherein the zoom lens comprises an aberration-changing lens unit comprising one or more lenses and configured to change aberration of the zoom lens by being inserted into and removed from an optical path in the rear lens unit; and,
wherein the zoom lens comprises a switching unit for switching between an arrangement state in which the aberration-changing lens unit is arranged in the optical path in the rear lens unit and a retracted state in which the aberration-changing lens unit is retracted from the optical path,
wherein the following inequalities are satisfied,
0.80≤fwa/fw≤1.20
0.95≤skwa/skw≤1.05
where fw represents a focal length of the zoom lens at the wide angle end in the retracted state, fwa represents a focal length of the zoom lens at the wide angle end in the arrangement state, skw represents a back focus at the wide angle end in the retracted state, and skwa represents a back focus at the wide angle end in the arrangement state.
